(19) United States
(12) Patent Application Publication
(10) Pub. No.: US 2022/0116737 A1
(43) Pub. Date: Apr. 14, 2022

(54) METHODS AND SYSTEMS FOR PROVIDING CONTEXT BASED INFORMATION

(71) Applicant: 1904038 ALBERTA LTD. o/a SMART ACCESS, Edmonton (CA)

(72) Inventors: John M. White, Edmonton (CA); Timothy Regnier, Edmonton (CA); Jonathan Smelquist, Edmonton (CA); Kyle Jeske, Edmonton (CA); Serguei Roupassov, Edmonton (CA)

(21) Appl. No.: 17/560,463

(22) Filed: Dec. 23, 2021

Related U.S. Application Data
(63) Continuation of application No. PCT/IB2020/056979, filed on Jul. 23, 2020.
(60) Provisional application No. 62/877,607, filed on Jul. 23, 2019.

(51) Int. Cl. H04W 4/021; H04W 8/20; G06F 16/9537

(52) U.S. Cl. CPC H04W 4/021; G06F 16/9537; H04W 8/20

(57) ABSTRACT

Methods and systems are described for providing content based on context. An example method may comprise receiving, from a user device, a request comprising data indicative of a location of the user device. The method may comprise determining, based on receiving the request, user information associated with a user of the user device. The method may comprise generating, based on the user information and the data indicative of the location, an information profile relevant to a context of the user at the location. The method may comprise transmitting, to the user device, the information profile.

### CROSS-REFERENCE TO RELATED APPLICATIONS

This application is a continuation of International Patent Application No. PCT/IB2020/056979, filed Jul. 23, 2020, which in turn claims priority to U.S. Provisional Application No. 62/877,607 filed Jul. 23, 2019, both of which are hereby incorporated by reference in their entirety for any and all purposes.

### BACKGROUND

The body of electronically stored information continues to expand at a fast pace. It can be difficult to find information quickly. Typical search interfaces are not optimized for the providing information in a specific location. A user at a location or performing a specific task may have different needs than another user at the same location. Thus, there is a need for more sophisticated techniques for delivering information.

### SUMMARY

Methods and systems are described for providing content based on context. An example method may comprise receiving, from a user device, a request comprising data indicative of a location of the user device. The method may comprise determining, based on receiving the request, user information associated with a user of the user device. The method may comprise generating, based on the user information and the data indicative of the location, an information profile relevant to a context of the user at the location. The method may comprise transmitting, to the user device, the information profile.

An example method may comprise determining a triggering event associated with an environment. The method may comprise determining, based on triggering event, user information and data indicative of a location of a user device associated the environment. The method may comprise generating, based on the user information and the data indicative of the location, an information profile relevant to a context of a user at the location. The method may comprise transmitting, to the user device, the information profile.

An example method may comprise determining, based on data associated with a user device, one or more triggering features. The one or more triggering features may be features associated with processing imaging data comprising one or more images of an environment in which the user device is located. The method may comprise determining, based on an association of the one or more triggering features and location information associated with the environment, an inferred location of the user device in the environment. The method may comprise determining, based on the inferred location and user information associated with the user device, an information profile. The method may comprise causing the information profile to be output via the user device.

An example method may comprise generating, by a user device, imaging data associated with an image sensor and comprising one or more images of an environment in which the user device is located. The method may comprise determining, based on processing the imaging data, one or more triggering features. The method may comprise sending, to a computing device, a request for information associated with the one or more triggering features. The method may comprise receiving, based on sending the request, an information profile. The information profile may be based on an inferred location of the user device in the environment and user information associated with the user device. The inferred location may be based on an association of the one or more triggering features and location information associated with the environment. The method may comprise causing, based on receiving the information profile, output of the information profile.

An example method may comprise storing location information associated with an environment and determining an association of one or more triggering features with corresponding portions of the location information. The one or more triggering features may comprise a feature associated with processing an image of the environment. The method may comprise determining an association of asset information with the one or more triggering features and the location information. The method may comprise causing, based on determining data indicative of the one or more triggering features and associated with imaging data of a user device, output, via the user device, of an information profile comprising the asset information. The information profile may be based on an inferred location associated with the user device and user information associated with the user device.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE DRAWINGS

The accompanying drawings, which are incorporated in and constitute a part of this specification, illustrate embodiments and together with the description, serve to explain the principles of the methods and systems.

FIG. 1 is a block diagram of an example system in accordance with the present disclosure.

FIG. 2 is a block diagram of an example content platform in accordance with the present disclosure.

FIG. 3A is a flowchart showing an example process for deploying a plurality of triggers.

FIG. 3B shows an example user interface image.

FIG. 3C shows an example user interface image.

FIG. 3D shows an example user interface image.

FIG. 3E shows an example user interface image.

FIG. 3F shows an example user interface image.

FIG. 3G shows an example user interface image.

FIG. 3H shows an example user interface image.

FIG. 3I shows an example user interface image.

FIG. 3J shows an example user interface image.

FIG. 3K shows an example user interface image.

FIG. 3L shows an example user interface image.

FIG. 3M shows an example user interface image.

FIG. 3N shows an example user interface image.

FIG. 3O shows an example user interface image.

FIG. 3P shows an example user interface image.

FIG. 3Q shows an example user interface image.

FIG. 3R shows an example user interface image.

FIG. 3S shows an example user interface image.

FIG. 4 is an example user interface for an application for accessing information relevant to a context.

FIG. 5 is a diagram showing an example cycle of accessing information relevant to a context.

FIG. 6 is a block diagram illustrating an example computing device.

FIG. 7 show an example system for providing information.

FIG. 8 shows an example of location information represented as a layout of an environment.

FIG. 9 shows another example of location information represented as a planogram of a rack.

FIG. 10 shows another example of location information represented in a data structure.

FIG. 11 shows another example of location information represented as a layout of an environment.

### DETAILED DESCRIPTION OF ILLUSTRATIVE EMBODIMENTS

Disclosed herein are methods and systems for more efficiently provide information associated with an environment. The disclosed methods and systems provide more efficient user interfaces that eliminate the need for individual users with different roles in the environment to use different applications and/or repeat the same searches for information. The disclosed methods and systems provide for obtaining information specific to various locations in the environment. Assets, structures, equipment and other features may be associated with different information. This information may also be different for different types of users. The disclosed methods and systems configure a user device to more efficiently deliver the right information for the right user, specific to a location, asset, structure, time of day, and/or the like. This increase in efficiency configures user devices (e.g., which are likely battery powered) to use less power and bandwidth because a user may spend less time browsing for information relevant to their role and/or relevant to a specific location.

The disclosed methods and systems allow for integration of learning, such as machine learning and other artificial intelligence, to identify gaps in information and/or other problems with procedures, training, operations, and/or the like. User profiles may also be modeled and used to customize the information in a specific information module. The disclosed methods and systems also allow for integration of business logic (e.g., from enterprise resource planning software, business process management data) into an information system to more efficiently trigger users to perform actions (e.g., while also providing at the same time the most up to date and relevant information for these actions). The disclosed methods and systems also configure user devices to more efficiently discover location specific information by configuring the user devices to scan, image, or otherwise determine location specific features that are associated with location, information, and/or the like. These efficiencies and others described herein provide for improved system efficiency, device efficiency, less battery usage, less usage of bandwidth (e.g., as less searching is required), as well as the increased leverage of information and connectivity between conventionally disparate systems.

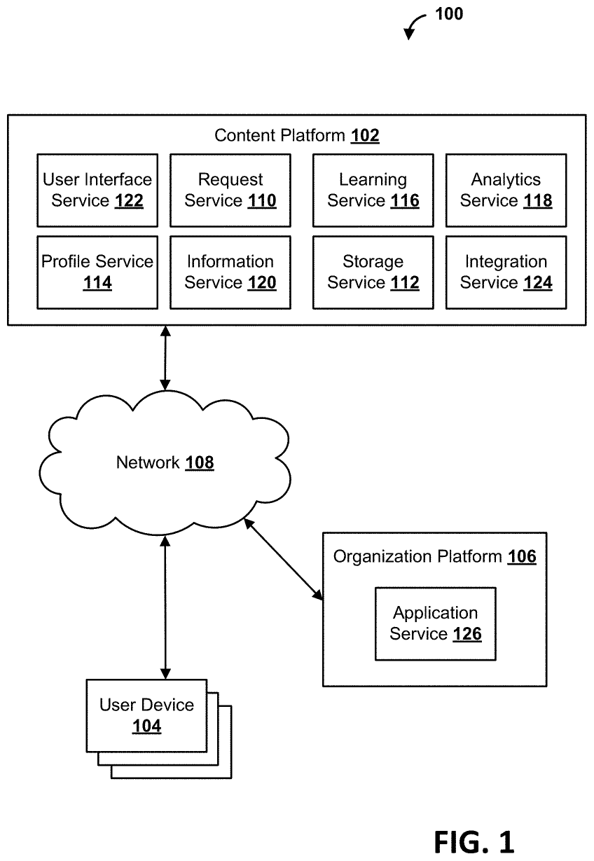

FIG. 1 is a block diagram an example system 100 in accordance with the present disclosure. The system 100 may comprise a content platform 102. The content platform 102 may comprise one or more computing devices, such as servers. The content platform 102 may be configured to receive requests for content from one or more users devices 104. The content platform 102 may be configured to communicate with an organization platform 106.

The system 100 may comprise a network 108. The network 108 may be configured to communicatively couple one or more of the content platform 102, the organization platform 106, the one or more user devices 104, and/or the like. The network 108 may comprise a plurality of network devices, such as routers, switches, access points, switches, hubs, repeaters, modems, gateways, and/or the like. The network 108 may comprise wireless links, wired links, a combination thereof, and/or the like.

The one or more user devices 104 may comprise a computing device, such as a mobile device, a smart device (e.g., smart watch, smart glasses, smart phone, hand held device), a computing station, a laptop, a tablet device, and/or the like. The one or more user devices 108 may be configured to output one or more user interfaces, such as a user interface associated with the content platform 102, the organization platform 105, and/or the like. The one or more user interfaces may be caused to be output by an application.

The one or more user devices 104 may be configured to determine location information. The location information may comprise one or more of an asset location at a premises, a premises location, a global positioning coordinate, a geospatial location within a premises, a location history, a shelf location, a premises zone, a container, an aisle, a department of a premises, a common space (e.g., a park, landmark or parking lot), a vehicle, an automobile, a location range, a tagged location, a combination thereof, and/or the like. The location information may be determined based on a positioning system of the user device 104. The positioning system may comprise one or more of a global positioning system, a wireless signal positioning system, an ultrawide band positioning system, a sound based positioning system, a beacon based positioning system, a Bluetooth beacon positioning system, an antenna/receiver based system, an inertial positioning system, an accelerometer, a device (e.g., tag) that advertises its location (e.g., and other data) to the user, a combination thereof, and/or the like.

The location information may be determined based on triangulation using one or more signals, such as wireless signals, satellite signals, Bluetooth signals, and/or ultrawide band signals. The location information may be received by the user device 104 from a positioning system.

The location information may comprise data indicative of a location. The data indicative of a location may comprise an identifier associated with a location, such as a location identifier. The location identifier may be received from a trigger or tag, a near field communication (NFC) tag, a code, bar code, quick response (QR) code, a beacon, a signal, a combination thereof, and/or the like.

The user device 104 (e.g., or the application) may be configured to determine (e.g., detect) a triggering event. The triggering event may comprise receipt of location information, data indicative of a location, a location identifier, and/or the like. The triggering event may comprise detecting that the user device has entered a location, a premises, a premises location, a global positioning coordinate, a geospatial location within a premises, a location history, a shelf location, a premises zone, a container, an aisle, a common space, a department of a premises, a location range, and/or a tagged location.

The triggering event may comprise scanning an identifier physically located at the location. The identifier may be stored in a tag (e.g., NFC or RFID tag), a QR code, a bar code, or other physical identifier. As an example, a plurality of identifiers (e.g., tags or triggers) may be disposed (e.g., or positioned) at corresponding locations within a premises. An identifier may be disposed (e.g., or positioned) on a shelf. The identifier may be disposed (e.g., or positioned) proximate to (e.g., or onto) an asset (e.g., object, equipment, station, product). The identifier may be scanned by the user or may be scanned automatically if the user is in range.

The user device 104 (e.g., application) may be configured to send a request based on the triggering event. The request may comprise the location information (e.g., or data indicative of the location). The request may comprise timing information (e.g., a current time, time stamp), user information (e.g., user skill level, user account identifier), identifying information (e.g., user identifier, device identifier, location identifier, tag identifier, universal unique identifier, collision resistant unique identifier, globally unique identifier), event information (e.g., prior events or interactions of the user and/or associated with a location), predictive interactions (e.g., based on logic rule and/or automated machine created response), a combination thereof, and/or the like. The request may comprise or be associated with a request for information. The request may be sent to one or more of the content platform 102 or the organization platform 106. The organization platform 106 may be managed by an organization that manages the location. The organization may manage a premises, asset, service, product, and/or the like at the location. The organization platform 106 may query the content platform 102 to determine information to respond to the request.

The content platform 102 may be configured to determine information based on the request. The determined information may comprise business information, such as know how, operational information, service information, maintenance information, sales information, loyalty information, inventory, supply chain information, human resource information, chain of custody, payment information a combination thereof, and/or the like. The business information may be relevant to a business associate, such as an employee, supervisor, manager, owner, sales representative, cashier, vendor, operator, trainer, dispatcher, inspector, official, and/or the like. The determined information may be relevant to or comprise customer information, customer profile, customer data, such product information, price information, store information, distribution information and/or the like. The customer information may be relevant to a customer at the location.

The content platform 102 may comprise a request service 110 configured to receive request from the one or more user devices 104. The request service 110 may be configured to determine information related to the request, such as a context of the request. The request service 110 may analyze the location information to determine an asset. The term asset as used herein may comprise any interest (e.g., tangible or intangible business interest) or concern. The asset may comprise an object, product, service, fixture, equipment, and/or the like. Both physical assets and virtual assets (e.g., abstract quantity, data point) associated with the request. The term asset may comprise an action, such as a service, a sales pitch, information delivery, an operation, a repair, movement, data collection, consumer tracking, and/or the like.

The request service 110 may be configured to query the storage service 112 to determine the asset. The location information (e.g., an identifier) may be associated with the asset in a data store managed by the storage service 112. The storage service 112 may be any data store, such as a database, distributed data partition, data structure, and/or the like. The storage service 112 may retrieve asset information associated with the asset. The asset information may comprise an install date, a usage date, a part number, a service history, a location, a builder, a creator, list of questions (e.g., frequently asked questions and answers), a decommission date, a decommission circumstances (e.g., rules for decommissioning the asset), an interaction history, task information (e.g., completed tasks of attendance), installation instructions, maintenance information (e.g., maintenance protocols), operational information (e.g., instructions for operating), safety information, a combination thereof, and/or the like.

The request service 110 may be configured to query the storage service 112 to determine user information. The user information may comprise a user identifier, a user profile, a user characteristic, a user experience level, a user skill level, a user permission level, a user role, a user type, an event or behavior associated with a user, metadata associated with a user, and/or the like. The storage service 112 may store a user profile (e.g., for each user of a plurality of users) comprising one or more user characteristics. A user characteristic may comprise one or more of a user role, a user experience level, a prior event associated with a user, a user permission level, user attribute(s) or occurrence of a set of events or attributes, and/or the like.

A profile service 114 may be configured to collect user information and/or store the user information in the storage service 112. The user information may comprise user metadata. The user metadata may comprise any data point, such as an event or behavior, associated with a user. The profile service 114 may store the user information as a profile (e.g., a collection of data associated with a user identifier). The user information may comprise, a user identifier, a user type (e.g., customer, employee, vendor, administrator), a user role (e.g., associate, salesperson, manager, supervisor, owner), a user demographic (e.g., gender, age, race, language), user contact information, and/or the like.

The profile service 114 may be configured to track user events (e.g., or other metadata, data points). The profile service 114 may cause storage of the events in the storage service 112. The user events (e.g., or other user metadata) tracked for a user may be different for different types of users (e.g., or different user roles). For an employee, events may comprise achievement events, training events, sales events, maintenance events, break events, sick events, injury events, project start events, project completion events, and/or the like. For a customer, events may comprise purchase events, inquiry events (e.g., user requests information), service events (e.g., service performed for a user), action events (e.g., premises arrive/leave, zone arrive/leave, department arrive/leave, aisle arrive/leave, container arrive/leave, bin or container arrive/leave, asset arrive/leave, object arrive/leave), and/or the like.

The profile service 114 may be configured to track location events. A location event may comprise an event associated with a location, an asset at the location, an object at the location, a service at the location, an action at the location, and/or the like. The location events may be associated with a location identifier, such as tag or other trigger disposed at a location, an identifier associated with a precise physical location. A premises (e.g., or environment) may be associated with a plurality of physical locations at the premises. The premises (e.g., or environment) may be logically subdivided into a plurality of physical points, a plurality of zones, a plurality of regions, and/or the like. For example, each asset (e.g., product, fixture, door, wall, machine) may have an associated zone (e.g., or location area) assigned to the asset. An asset may be assigned a zone large enough (e.g., within 3 feet of the asset's location on a shelf) to determine if a user is interacting with (e.g., looking at it, picking it up, learning about) the asset. If a user enters the zone, the profile service 114 may track the event. The user device 104 may send an indication of the location (e.g., or of the user entering the zone) to the profile service 114. The profile service 114 may store the indication as an event. If tags are used, a user device 104 may interact with the tag. The user device 104 may send an indication of the interaction with the tag to the content platform 102. The content platform 102 may cause the profile service 114 track the indication as a location event.

The content platform 102 may comprise a learning service 116. The learning service 116 may be configured to determine user characteristics, trends, patterns, and/or the like. The learning service 116 may comprise one or more rules for determining user characteristics. The rules may map events, sequences of events, and/or the like with corresponding user characteristics (e.g., which may be stored as part of the user's profile). For example, if a customer purchases products at least once a month from a business, the customer may be given a characteristic of frequent shopper. A rule may associate achievement of a goal (e.g., or value of a metric) with a user characteristic, such as user skill, user achievement, user experience level, and/or the like. A goal may comprise a number of occurrences of an event, a count of a metric, and/or the like. The goal may be based on any measurable metric. An organization may define different goals for users to achieve to qualify to be assigned different user characteristic. The goal and/or metric may be associated with a location, location identifier, asset, service, and/or the like.

The learning service 116 may be configured to identify patterns based on metadata, events, metrics, goals, and/or the like. The learning service 116 may determine patterns for a single user, for multiple user, for a group of users, a combination thereof, and/or the like. The learning service 116 may determine patterns associated with a location (e.g., physical or virtual), a group of locations, an asset, a service, and/or the like. For example, the learning service 116 may determine a pattern in which a user visits a first location followed by a visit to a second location. For a first pattern, if the user is of a first type, the user may visit the first location and second location. For a second pattern, if the user is of a second type, the user may visit the first location and a third location.

The learning service 116 may analyze metadata associated with each location and/or the pattern. The metadata may comprise a textual description of the location, of an asset at the location, of a service at the location, and/or the like. Keywords in the textual description (e.g., whether indicated or automatically recognized) may be compared for different locations to determine similarity, differences, and/or associations between the different keywords. The patterns may be analyzed to determine behaviors. For example, if a user is an associate (e.g., sales associate, supervisor, manager), the user may walk from a department location to a break room. A pattern may emerge that the associate always stops at a certain location between the break room and department. For example, customers may stop the associate in an area that has poorly defined product explanations. The learning service may recognize the pattern and store the pattern in the storage service 112. A pattern may comprise an association between a location (e.g., or asset/service at a location) and relevant information.

The learning service 116 may generate one or more models associated with users, locations, assets, services, information profiles, content, and/or the like. The model may be generated based on machine learning, artificial intelligence, and/or the like. The model may be generated based on supervised learning, unsupervised learning, decision trees, feature learning, anomaly detection, association rules, neural networks, support vector machines, Bayesian networks, genetic algorithms, a combination thereof, and/or the like. The one or more models may be predictive models. The one or more models may predict associations between locations, users and locations, users and services, users and assets, users and information profiles, users and content, assets and services, and/or the like. The one or more models may be trained by a data set, such as prior data. The one or more models may be trained and/or updated as new data is obtained about a location, asset, service, user, and/or the like.

The learning service 116 may be configured to predict (e.g., or learn) information relevant to a context. The context may comprise any information associated with a location, asset, service, premises, user, content, and/or the like. The learning service 116 may predict the information relevant to the context based on the one or more rules, pattern recognition, the one or more models, and/or the like. User information, asset information, service information, premise information, profile information, content, and/or the like may be correlated using the one or more rules to corresponding information relevant to the context. The one or more rules may be updated and/or changed based on pattern recognition, machine learning, manual adjustment, and/or the like.

The content platform 102 may comprise an analytics service 118. The analytics service 118 may comprise an interface for manually entering the one or more rules. The analytics service 118 may be configured to output learned patterns, information from the one or more rules, suggestions to add rules, suggestions to update rules, and/or the like. The analytics service 118 may be configured to output a suggestion to update an information profile. A user can approve the suggestion. If approved, the content platform 102 may update and/or add the rule.

The content platform 102 may comprise an information service 120. The information service 120 may be configured to provide information, such as information relevant to a context (e.g., asset, location, user information). The information may be provided in an information profile. An information profile may comprise a data structure (e.g., or a representation of data) comprising the information. The information profile may comprise one or more information modules. An information module may comprise a set of information, such as an information page. An information module may comprise a widget, functional code block, applet, scripting module, coded module configured to deliver a specific type of information (e.g., according to a specifically programmed format or functionality), combination thereof, and/or the like

The request service 110 may call the information service 120 to provide information relevant to a request associated with the user. The request service may provide a context to the information service 120. The context may comprise user information, location information, asset information, service information, and/or the like. The information service 120 may be configured to use the one or more rules, patterns, one or more models, and/or the like to determine the information relevant to the context. The one or more rules, patterns, one or more models, and/or the like may be used to determine one or more information modules. The information service 120 may manage information profile generation rules associating specific context information with corresponding information modules. An information module may comprise a video module, image module, media module, comment module, a summary module, a checklist module, a training module, a certification module, an application module, a custom code module, a payment module and/or the like.

A location, an asset associated with a location, a service associated with the location, and/or the like may have a prior defined information profile. For example, a location may be associated with an asset, such as a product. The asset may have a first set of information modules associated with a first type of user (e.g., consumer or the public), a second set of information modules associated with a second type of user (e.g., employee), a third type of information associated with a third type of user (e.g., supervisor, vendor), a combination thereof, and/or the like. The first set of information modules may be different than the second set of information modules and the third set of information modules. The information service 120 may be configured to receive user information, such as a type of the user associated with a request. The information service 120 may use the type of user in the context to determine which set of modules to provide for a particular request.

The information service 120 may be configured to remove and/or add additional information modules based on the context. A default set of information modules may be associated with a location, an asset associated with a location, a service associated with the location, a user associated with a location, a combination thereof, and/or the like. For example, the information service 120 may be configured to add and/or remove one or more information modules to/from the default set of information modules when they are not required in the particular user context.

The information service 120 may be configured to customize information in an information module based on the context. An information module may comprise an executable code set, such as a client-side script, a server-side script, a plugin, an executable module of computer readable code, and/or the like. The information module may comprise media, such as text, image, video, and/or the like. The information module may be configured to receive one or more parameters to modify the information in the information module. The information service 120 may directly modify information in the information module. Modifying information may comprise adding information, removing information, emphasizing information, deemphasizing information, and/or the like. The information service 120 may be configured to customize information in the information module based on the one or more rules, the patterns, the one or more models, and/or the like. If the context indicates that the user has a first experience level (e.g., or skill level), the information service 120 may provide technical information. If the context indicates that the user has a second experience level (e.g., lower than the first experience level), the information service 120 may add information indicating another associate with the first experience level (e.g., along with a location, contact info of the other associate) and/or may provide additional information (e.g., training, safety, and/or the like) in order to up-skill the user to an appropriate experience level. The user's interaction with this other content can be then be used by the learning service 116 or analytics service 118 to adjust the context of that user, asset, location, and/or the like.

The content platform 102 may be configured to optimize the relevancy of information provided by the information service over time. The information relevant to the context may be output to the user via a user interface (e.g., on the user device 104). The user interface may communicate with a user interface service 122. The user interface may send data indicative of a user's response to the information relevant to the context. The data may indicate which information modules the user interacted with, a duration of time viewing an information module, interactions with interface elements (e.g., video control, checklist), and/or the like. The data indicative of the user's response may be used to generate a rule, change a rule, determine a pattern, update a model, and/or the like. If an information module comprises a video, the data from several users may indicate a pattern that the users typically fast forward to one part of the video. The information module may generate a link to cause a video module to start at the relevant part of the video. The data may be specific to a user type (e.g., or user role). A customer may typically watch the entire video, while a salesperson may only access a part of the video. The link may be provided for the salesperson, but the entire video may be provided to the customer.

The information may be accessed and/or based on the training level of the worker, the responsibility level of the worker, what information has been updated into the system, and/or the like. Example information that accessed and/or generated may comprise work procedure information, employee tasks, tasks to be completed, task to be repeated, issues to be report on, daily checklists, weekly checklists, asset status, alerts/notifications/call-button, safety procedures, safety checklist, lock out procedures, lock out reporting, cleaning instructions, hazardous material management, live training, feedback portal, community learning, best practices, “newsfeed”, challenges, internal messaging, message boards, a combination thereof, and/or the like.

The information may be generated based on the training level of the worker, the responsibility level of the worker, what information has been updated into the system, a combination thereof, and/or the like. The information provided by the information module may comprise a task to be completed, a task to be repeated, issues to be reported on, daily checklists, weekly checklists, asset status, an alerts, a notification, a call-button, a safety procedure, a safety checklist, a lock out procedure, a lock out reporting, cleaning instructions, hazardous material management information, live training (e.g., or recorded video training), a feedback portal, community learning information (e.g., posts by users, best practices, a newsfeed, a challenge, internal messaging, message boards), a link to any of these items, a combination thereof, and/or the like.

The content platform 102 may comprise an integration service 124. The integration service 124 may be configured to communicate with external services, such as the organization platform 106. The integration service 124 may comprise an application programming interface (e.g., a set of accessible functions) for communicating with the content platform 102. The organization platform 106 may comprise an application service 126. The application service 126 may comprise any application managed by the organization. The application service 126 may comprise an application for managing assets, asset locations, and/or the like. The request service 110 may be configured to query the application service 126 to determine an asset and/or service associated with a location identifier. In some scenarios, the organization platform 106 may communicate with the user device. A request for information relevant to a context may be received by the organization platform 106 from a user device. The organization platform 106 may be configured to request information relevant to the context by querying the content platform 102.

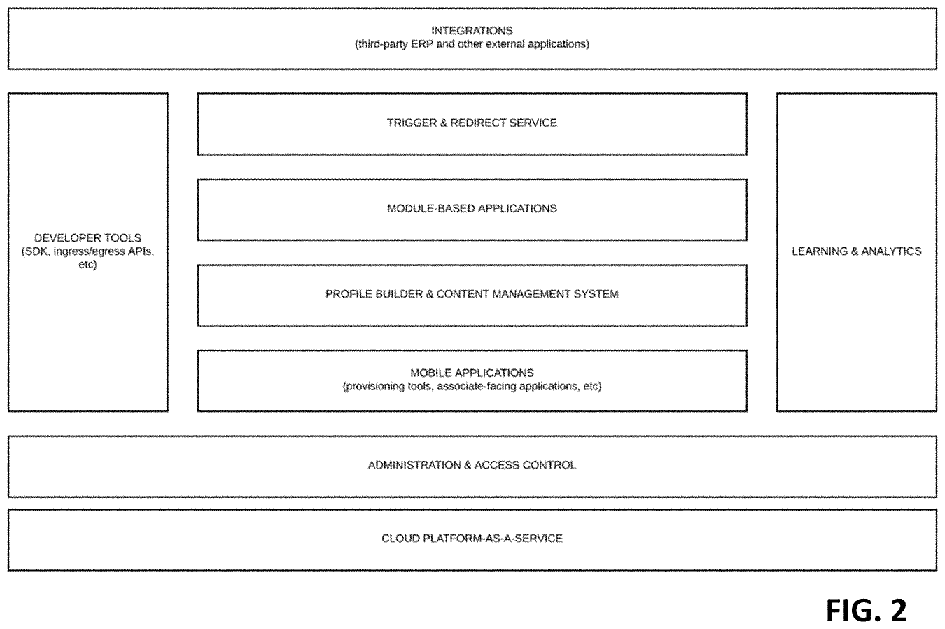

FIG. 2 is a block diagram of an example content platform in accordance with the present disclosure. The cloud platform as-a-service may comprise an instance of the organization platform. The Administration & Access Control may comprise user management and authentication services. The Mobile Applications may comprise tools for managing provisioning of triggers. The Mobile Applications may comprise user-facing applications for interacting with the content platform (e.g., content platform 102). The Profile Builder and Content Management System may comprise functionality to create, curate, and manage content and profiles (e.g., created by the content platform 102 or organization platform). The Module-based Applications may comprise a video module (e.g., configured to show videos), image module (e.g., configured to show images), media module (e.g., configured to show media), comment module (e.g., configured to allow users to share comments), a summary module (e.g., configured to show a summary of the information profile or other information), a checklist module (e.g., configured to show one or more checklists), a training module (e.g., configured to provide user training), a certification module (e.g., configured to show and/or update certification information, e.g., a manager may update certifications, an employee may view tasks to complete certifications), an application module (e.g., configured to provide an application), a custom code module (e.g., configured to run custom code specific to an implementation of the platform), a payment module (e.g., configured to allow and/or receive payments from users), and/or the like.

The Trigger and Redirect Service may comprise functionality that allows for creating, managing, and deploying a plurality of triggers with dynamic routing to the appropriate profile, content, and/or information profile. The Learning & Analytics may comprise functionality to create and report on models associated with users, locations, assets, services, information profiles, content, and/or the like. The Developer Tools may comprise integration, SDK, API and user interface design functionality to allow for third-party developer use of the platform. The Integrations may comprise pre-defined or custom integrations with third-party enterprise resource planning (ERP), user management, location management, asset management, content management or other integration with any of the aforementioned modules, profiles, applications, developer tools, learning and analytics tools, trigger and redirect service tools, administrative tools and/or the like.

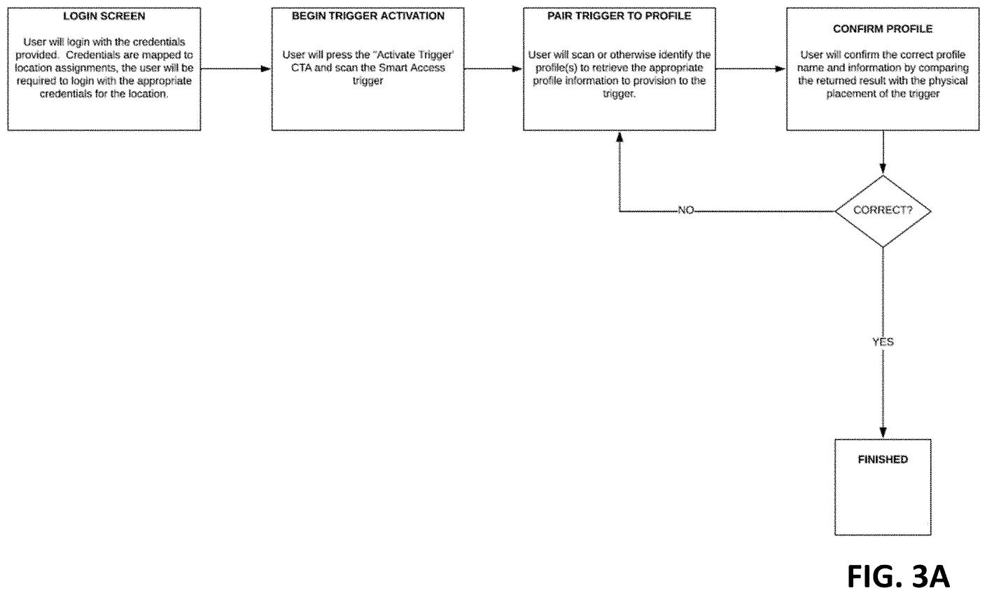

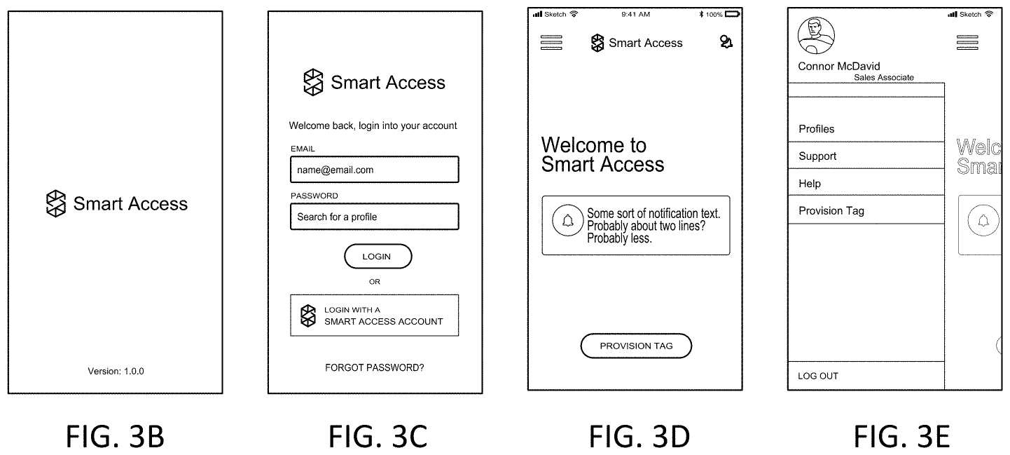

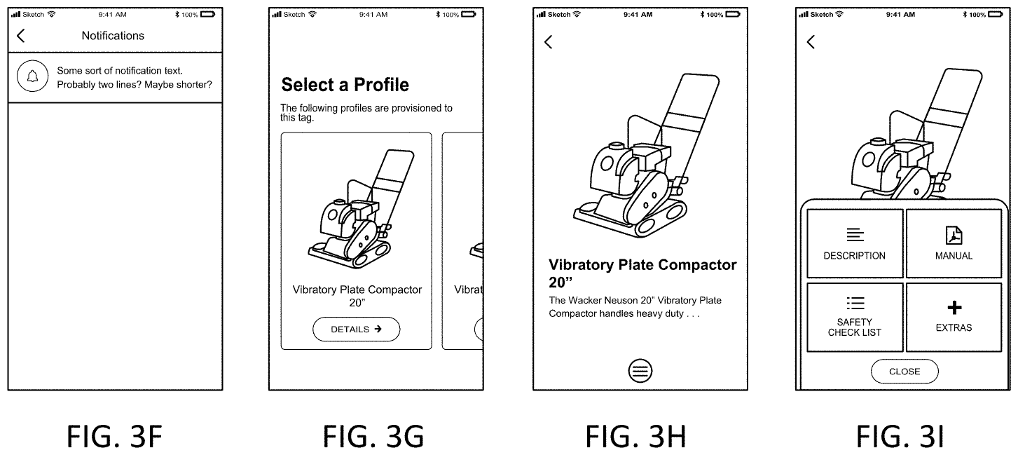

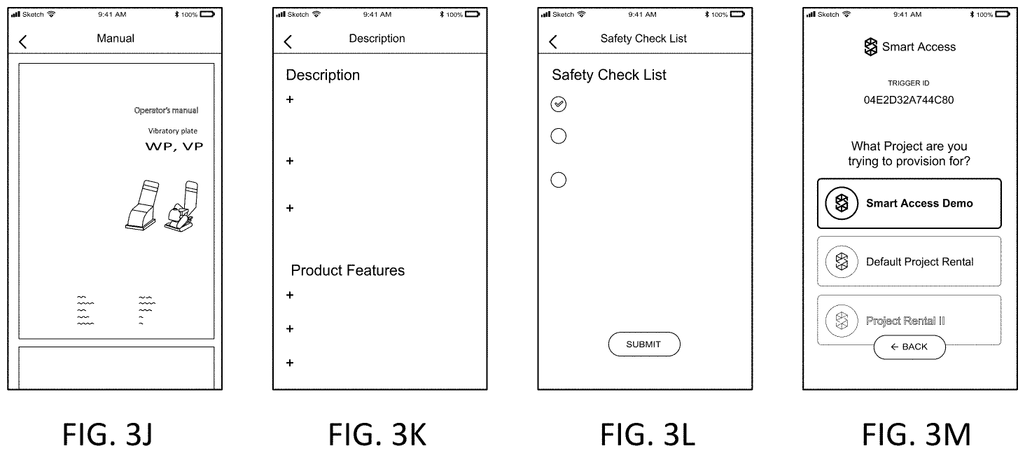

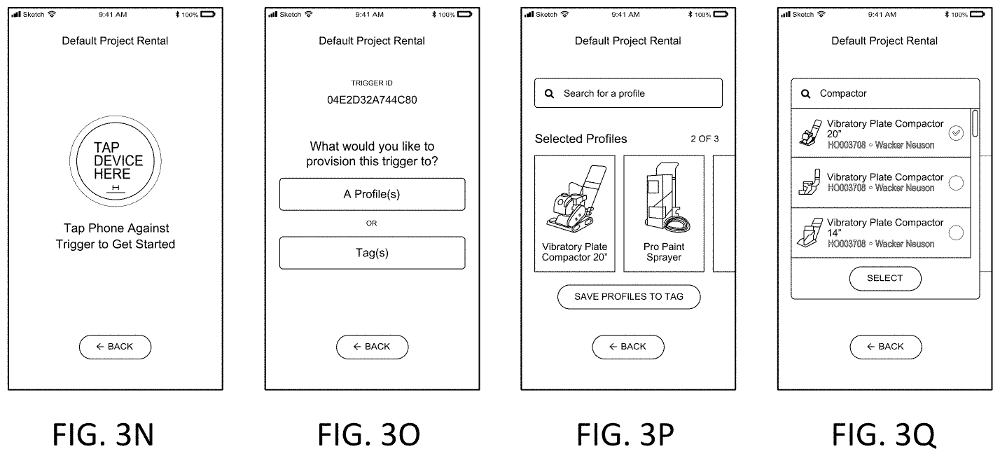

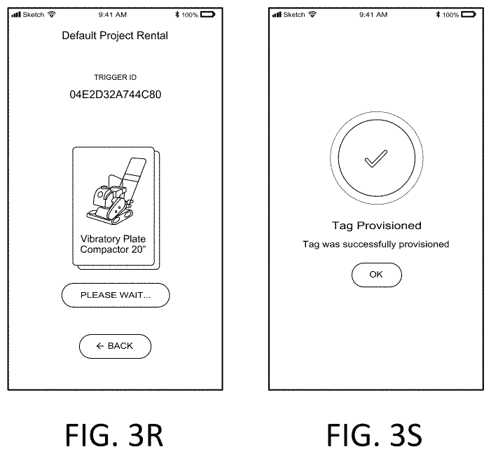

FIG. 3A is a flowchart showing an example process for deploying a plurality of triggers or tags. FIGS. 3B-3S show user interface images associated with the flow chart of FIG. 3A. FIGS. 3B-3F show example user interface representations of a splash screen, dashboard, and/or the like. FIGS. 3G-3L show example user interface representations of accessing an information profile, viewing an information profile, viewing product features, view checklists, and/or the like. FIGS. 3M-3S show example user interface representations of associating a trigger (e.g., a logical trigger) with one or more of a triggering feature (e.g., tag, imaging feature, shape, identifier, UPC, SKU, image, text, label), an asset, an information profile, a location, and/or the like. An organization may deploy a plurality of triggering features or tags at a premises (e.g., or environment). Each triggering feature may be disposed at a physical location (e.g., next to an asset, on an asset). Each triggering feature may be registered using an application. The triggering feature may be associated with a corresponding asset.

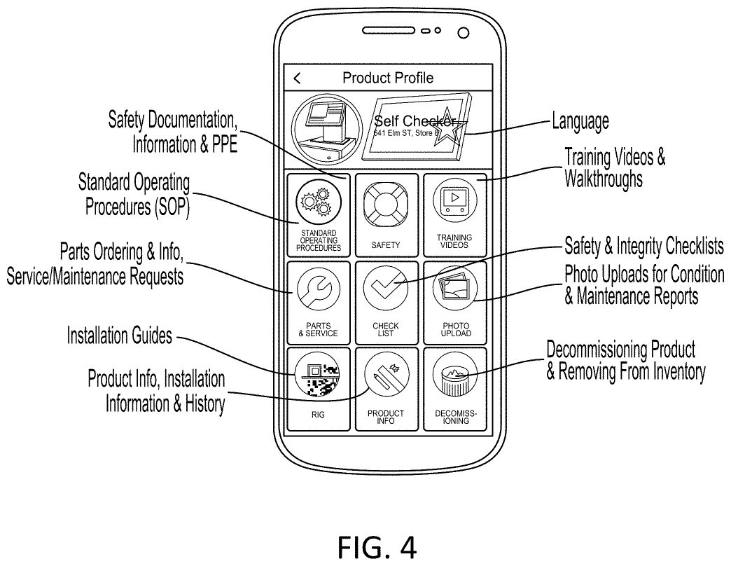

FIG. 4 is an example user interface for an application for accessing information relevant to a context. The example user interface may be a mobile device user interface. The mobile device may determine location information (e.g., based on a trigger, tag, signal). The user interface may be updated based on the location information. The user interface may comprise a plurality of information modules, such as information modules associated with job functions, information modules associated with management of assets (e.g., products, equipment, inventory), information modules associated with safety, information modules associated with performing actions in a business process, information associated with usage of assets after purchase, information modules associated with training, information modules with information for employees, or information modules with information not available to customers (e.g., information different than and/or supplemental to the product information displayed to customers).

The plurality of information modules may comprise a safety information module, a standard operating procedures module, a parts ordering and information module, a service and/or maintenance request module, an installation guide module, a product information module, a product information and history module, a training module (e.g., training videos and walk through), a checklist module (e.g., for safety and integrity checklists), a photo upload module (e.g., for condition and maintenance reports), a decommissioning module (e.g., for decommissioning assets and/or removing assets from inventory). The plurality of

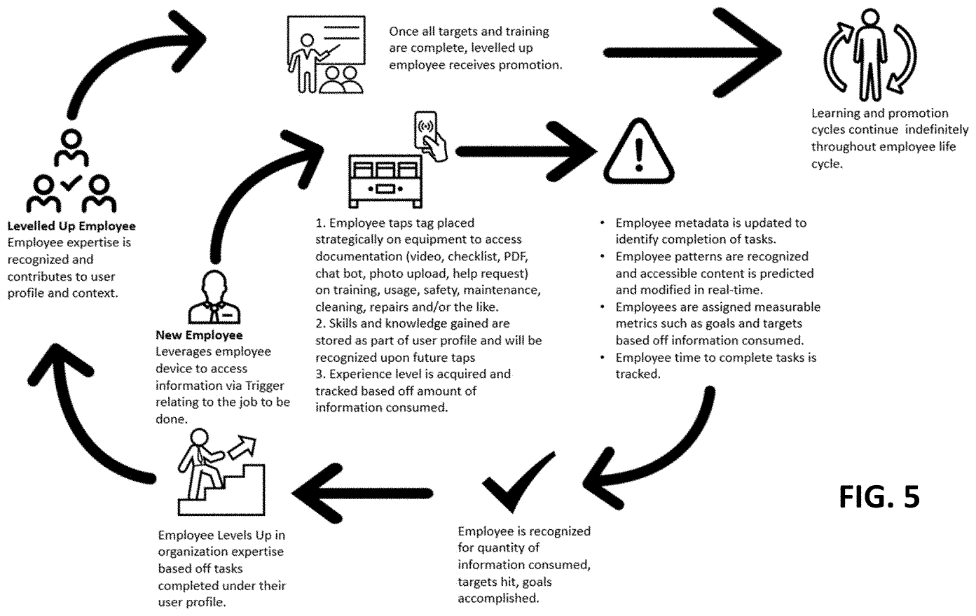

FIG. 5 is a diagram showing an example cycle of accessing information relevant to a context. A new employee (e.g., front-line worker) may engage with a strategically placed trigger to access training documentation relating to usage of a point of sale system (e.g., or other asset). Training may include log in/out, basic cash handling procedures, gift card authorization, returns, split payment, printer, debit/credit transactions, and/or the like.

The employee may gain knowledge and skills related to POS system through video, checklist, PDF, chatbot, photo upload, help request and/or the like. Employee knowledge, completion, and ranking is stored in a user profile. The user profile may be processed (e.g., analyzed using rules, patterns, models, artificial intelligence, machine learning) to determine metadata associated with POS knowledge and generate an experience level based on amount and quality of information consumed.

As the employee complete training related to point of sale system, other training and certification (e.g., cash training, supervisor, key owner, cash manager certification, and/or the like) may be made available on the user profile. A user profile may have varying experience levels for different trainings and/or certifications. The employee may be a beginner level for point of sale training but at an advanced level for stocking. The training and/or experience levels may be used to trigger sending of information to user devices. Updates to certification and training may be flagged on employee profile, and all future information and training consumed may be based off said certification. Flags could be displayed via alert notification, content curation, and/or the like.

The employee may be assigned new privileges based off training completion (e.g., or role, experience level). Privileges may include the ability to make price changes, assigning discounts, completing cash in/out procedures at the beginning and end of day, and/or the like. New privileges may be displayed in new content format as access to content is acquired. The employee may be assigned daily challenges related to products sold and transactions complete. User profile recognizes may be completed targets in real-time.

Once all targets and training are complete, the employee may level up in the system (e.g., be associated with the next highest level) and gain access to more advanced training knowledgebases. This cycle may continue indefinitely throughout employee life cycle.

Concurrently, other users of the system may engage with the same POS trigger to get contextual information about that store area or their job role areas of focus (e.g., custodial or maintenance staff would receive content about POS maintenance, cleaning procedures, parts re-order information, manufacturer help, and/or the like).

Over time, a learning service (e.g., learning service 116) may be configured to identify patterns based on metadata, events, metrics, goals, and/or the like. The learning service may determine patterns for a single user, for multiple users, for a group of users, for a single asset, for multiple assets, a group of assets, for a single location, for multiple locations, a group of locations, a combination thereof, and/or the like. For example, the learning service may determine that users typically get stuck on a portion of a training or task in an information model. A delay in completing the task may be determined. It may be determined that the user navigates to a browser to find more information. The information may automatically be added to the information profile and/or provided as a suggestion to a manager to add the information. A flag may be associated with the task to notify a manager of the content platform 102 to re-evaluate an information module. The user device may also prompt the user to flag a task of information module to indicate a problem.

The disclosed methods and systems may be used to implement a tool for providing know how, operational procedures and other information for an employee or member of an organization. A digital trigger and content curation platform that provides in-store and post-sale engagement, brand connectivity, and access to extended services through the user's smartphone (e.g., or other device) engagement with a trigger (a near field communication tag, a code, bar code, quick response (QR) code, a beacon, a signal, visual feature, a combination thereof, and/or the like). The services, engagement, and connectivity will help customers get the most out of a purchase or other transaction and allow an organization (e.g., company, store, restaurant) the ability to get closer to the customer post-sale. Digital content could include product how-to videos, specs and safety information, product sale price, installation instructions, installation booking, repair information, repair booking, accessory products, product or sales resources, pricing, warranty and extended warranty pricing, extended use pricing, and/or the like. These pieces of data and resources encourage a more efficient associate in the workplace leading to a more informed customer (e.g., in- and out-of-store).

By engaging with the trigger affixed to a product, price label, store rack, fixture, and/or the like, associates may be taken to a user interface (e.g., an organization branded user interface) that will allow them to see specifics of that product, and pertinent operational information; for example: product knowledge content, consultation, help, and/or installation; required attachment or accessory products; product up-sells, cross-sells, bundles; safe use information; return care; other SKU information & pricing. The information may allow the associate to assist another user with a different role (e.g., customer, service person). The content platform may be used by customers, the general public, employees, managers, and/or the like.

By engaging with the trigger affixed to a product, price label, store rack, fixture, and/or the like, customers are taken to a user interface (e.g., an organization branded user interface) that will allow them to see specifics of that product, and pertinent operational information, such as product knowledge content, consultation, help, and/or installation, required attachments, accessory products, product up-sells, cross-sells, bundles, safe use information, return care, other SKU information, pricing, a combination thereof, and/or the like.

The methods and systems disclosed may be used for implementing a digital manual for installing or managing fixtures and/or other assets at stores. An organization (e.g., company, store) may deploy new fixtures (e.g., or other assets) and in-store merchandising programs regularly. These assets are often custom to the organization and may have unique installation or merchandising instructions. As new assets are rolled out, and feedback from the field comes in from these teams, iterations to the instruction may be needed. Getting up to date installation instructions into the hands of those that need it most can be challenging.

Other issues can arise during installation, such as paper instructions can be misplaced, installers may need to dig through multiple boxes to find a part(s), instructions may not be followed precisely resulting in rework, and parts that seem extra can be thrown away when they are to be used for other installations. All resulting in costly “one off” replacements.

Conventionally, the organization can create installation instructions and distribute the content through email or within the kits. A more convenient and efficient system can be implemented as disclosed herein.

An example disclosed system can comprise a Digital Instruction Management Tool. The system can be accessed through different triggers. These triggers may be used to load content in a responsive web application and/or native application. The content may comprise up to date assembly instructions for installation or set up of purchased products (e.g. a bookshelf, desk, patio furniture, dishwasher, car stereo, toilet, chair and/or the like), eliminating lost install manuals, knowing what is in each box, and/or parts lists so the user know what goes where. The Digital Installation Management Tool can be configured in a step by step format to guide the user through the installation process. A final audit photo can be uploaded for verification or compliance.

The different triggers for the system can be NFC tags, QR codes, SMS and URL labels per kit, and/or other item identifier.

A digital assembly guide may be developed with step-by-step instructions, including text and various media (e.g., images/video). Content may be accessed via a responsive webpage and/or native app. The content may be device agnostic (e.g., web or mobile browser). Content can be edited throughout the project lifecycle by any authorized user.

The content platform may be triggered. Provisioning and management service for NFC tags, QR codes, SMS and email of instructions and associated step URLs.

The methods and systems disclosed may be used for communicating safety and other health considerations at a location. An organization (e.g., company, store, factory) may provide communication of safe use and other health considerations of a particular location, asset or job function. Communicating this information in an effective way may be enhanced through contextual awareness of the user, the user's job function, the user's role, prior training data, the user's location, and/or the like.

Conventionally, the organization can create health and safety materials and distribute the context through existing communication channels and/or place them in various portals. A more convenient and efficient system can be implemented as disclosed herein whereby the user is directed to content through engagement with a trigger (e.g., location based trigger) placed in context of the health or safety area (e.g., placed inside a semi-truck, on a forklift, in a HAZMAT area, and/or the like)

The methods and systems disclosed may be used for on the job training at a particular location. An organization (e.g., company, store, factory) may require training on various services, technology, tools, or other organizational programs regularly. This training is often custom to the organization and may have requirements based on context like the user's job role and function, the location and/or the like.

Conventionally, the organization can create training materials and distribute the content through email, presentations or place them in various portals. A more convenient and efficient system can be implemented as disclosed herein whereby the user is directed to location and job-specific training content through engagement with a trigger placed in context of the training area

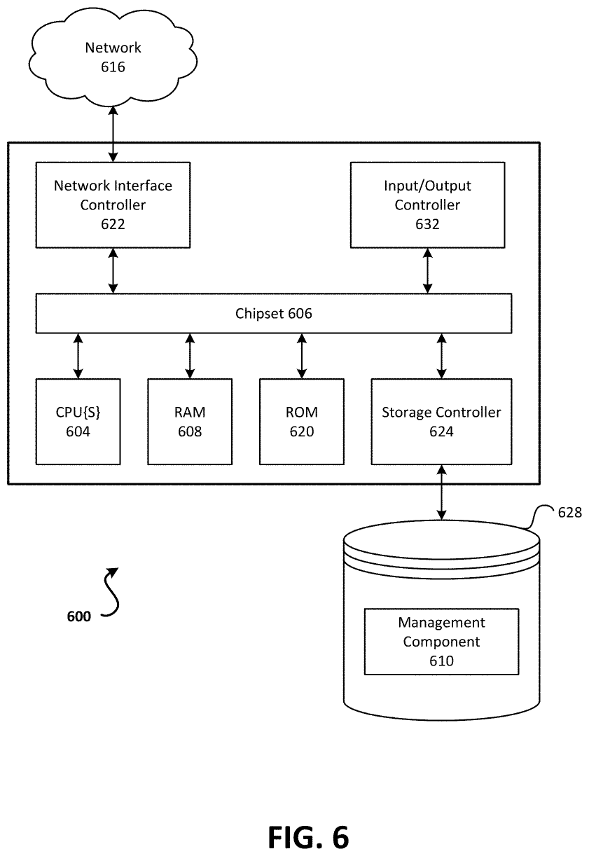

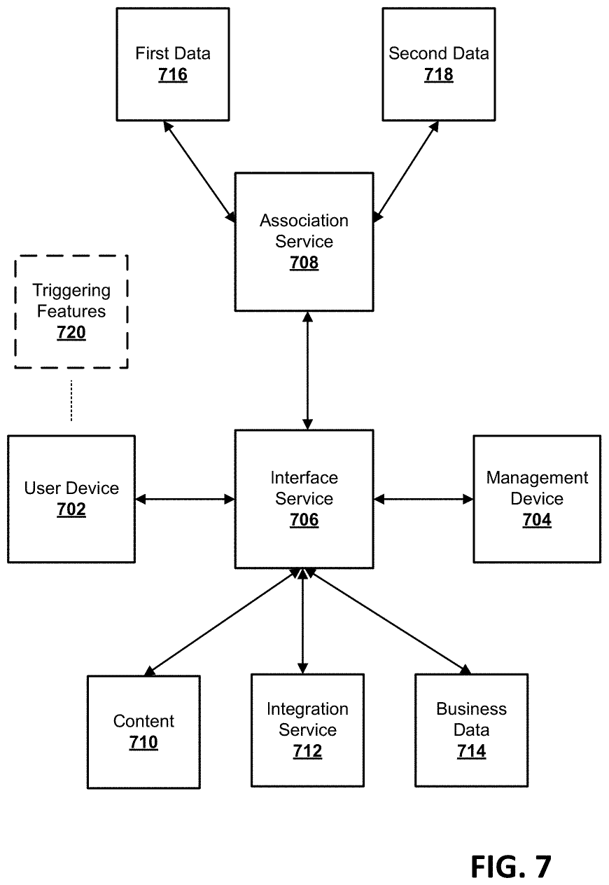

FIG. 6 depicts a computing device that may be used in various aspects, such as the servers, platforms, and/or devices depicted in FIG. 1, FIG. 2, and FIG. 7. With regard to the example architecture of FIG. 1, the content platform 102, the user device 104, and the organization platform 106 may each be implemented in as one or more instances of a computing device 600 of FIG. 6. With regard to the example architecture of FIG. 7, the user device 702, the interface service 706, the integration service 712, the management device 704, the association service 708 may each be implemented as one or more instances of computing device 600 of FIG. 6. The computer architecture shown in FIG. 6 shows a conventional server computer, workstation, desktop computer, laptop, tablet, network appliance, PDA, e-reader, digital cellular phone, or other computing node, and may be utilized to execute any aspects of the computers described herein, such as to implement the methods described herein.

The computing device 600 may include a baseboard, or “motherboard,” which is a printed circuit board to which a multitude of components or devices may be connected by way of a system bus or other electrical communication paths. One or more central processing units (CPUs) 604 may operate in conjunction with a chipset 606. The CPU(s) 604 may be standard programmable processors that perform arithmetic and logical operations necessary for the operation of the computing device 600.

The CPU(s) 604 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 604 may be augmented with or replaced by other processing units, such as GPU(s) 605. The GPU(s) 605 may comprise processing units specialized for but not necessarily limited to highly parallel computations, such as graphics and other visualization-related processing.

A chipset 606 may provide an interface between the CPU(s) 604 and the remainder of the components and devices on the baseboard. The chipset 606 may provide an interface to a random access memory (RAM) 608 used as the main memory in the computing device 600. The chipset 606 may further provide an interface to a computer-readable storage medium, such as a read-only memory (ROM) 620 or non-volatile RAM (NVRAM) (not shown), for storing basic routines that may help to start up the computing device 600 and to transfer information between the various components and devices. ROM 620 or NVRAM may also store other software components necessary for the operation of the computing device 600 in accordance with the aspects described herein.

The computing device 600 may operate in a networked environment using logical connections to remote computing nodes and computer systems through local area network (LAN) 616. The chipset 606 may include functionality for providing network connectivity through a network interface controller (NIC) 622, such as a gigabit Ethernet adapter. A NIC 622 may be capable of connecting the computing device 600 to other computing nodes over a network 616. It should be appreciated that multiple NICs 622 may be present in the computing device 600, connecting the computing device to other types of networks and remote computer systems.

The computing device 600 may be connected to a mass storage device 628 that provides non-volatile storage for the computer. The mass storage device 628 may store system programs, application programs, other program modules, and data, which have been described in greater detail herein. The mass storage device 628 may be connected to the computing device 600 through a storage controller 624 connected to the chipset 606. The mass storage device 628 may consist of one or more physical storage units. A storage controller 624 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 600 may store data on a mass storage device 628 by transforming the physical state of the physical storage units to reflect the information being stored. The specific transformation of a physical state may depend on various factors and on different implementations of this description. Examples of such factors may include, but are not limited to, the technology used to implement the physical storage units and whether the mass storage device 628 is characterized as primary or secondary storage and the like.

For example, the computing device 600 may store information to the mass storage device 628 by issuing instructions through a storage controller 624 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 600 may further read information from the mass storage device 628 by detecting the physical states or characteristics of one or more particular locations within the physical storage units.

In addition to the mass storage device 628 described above, the computing device 500 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 600.

By way of example and not limitation, computer-readable storage media may include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that may be used to store the desired information in a non-transitory fashion.

A mass storage device, such as the mass storage device 628 depicted in FIG. 6, may store an operating system utilized to control the operation of the computing device 600. The operating system may comprise a version of the LINUX operating system. The operating system may comprise a version of the WINDOWS SERVER operating system from the MICROSOFT Corporation. According to further aspects, the operating system may comprise a version of the UNIX operating system. Various mobile phone operating systems, such as IOS and ANDROID, may also be utilized. It should be appreciated that other operating systems may also be utilized. The mass storage device 628 may store other system or application programs and data utilized by the computing device 600.

The mass storage device 628 or other computer-readable storage media may also be encoded with computer-executable instructions, which, when loaded into the computing device 600, transforms the computing device from a general-purpose computing system into a special-purpose computer capable of implementing the aspects described herein. These computer-executable instructions transform the computing device 600 by specifying how the CPU(s) 604 transition between states, as described above. The computing device 600 may have access to computer-readable storage media storing computer-executable instructions, which, when executed by the computing device 600, may perform the methods described herein.

A computing device, such as the computing device 600 depicted in FIG. 6, may also include an input/output controller 632 for receiving and processing input from a number of input devices, such as a keyboard, a mouse, a touchpad, a touch screen, an electronic stylus, or other type of input device. Similarly, an input/output controller 632 may provide output to a display, such as a computer monitor, a flat-panel display, a digital projector, a printer, a plotter, or other type of output device. It will be appreciated that the computing device 600 may not include all of the components shown in FIG. 6, may include other components that are not explicitly shown in FIG. 6, or may utilize an architecture completely different than that shown in FIG. 6.

As described herein, a computing device may be a physical computing device, such as the computing device 600 of FIG. 6. A computing node may also include a virtual machine host process and one or more virtual machine instances. Computer-executable instructions may be executed by the physical hardware of a computing device indirectly through interpretation and/or execution of instructions stored and executed in the context of a virtual machine.

Additional aspects of the disclosure are described below. Any of the following aspects may be implemented via the systems described above. The following aspects may be combined in any manner with each other and/or the aspects described elsewhere herein. The content platform 102, the organization platform 106, or a combination thereof may be configured to perform any of the features described below. Any of the features below may be used for determining user information, determining information profiles, determining location information, and/or the like.

Smart Triggering

The systems described herein may be configured to perform smart triggering, such as triggering a request for information or the automatic sending of information without requiring user interaction. Normally a user would manually interact with a triggering feature (e.g., by tapping the trigger, by capturing an image), thereby invoking content on demand. However, a trigger can also be automatic (e.g., passive), occurring without the user having to actively invoke it. Automatic triggering can be based on a user device entering/leaving a geofenced location, a user device being in proximity (e.g., within a threshold distance) of other users (e.g., perhaps of certain type or performing certain actions), a user device being in a location within a specific timeframe, a combination thereof, and/or the like. Automatic triggering can be performed by a user device. The user device can be configured based on a triggering process. The triggering process may be based on rules, pattern recognition, artificial intelligence, machine learning (e.g., if no external signal is required), and/or the like. The triggering process may be based on a context provided by a server. The context may comprise information about other users, business information (e.g., inventor), business process information and/or logic (e.g., from an ERP)

The triggering process may be based on geofencing, timing information, event information, other user information, business rules, a combination thereof, and/or the like. Geofencing based on triggering may comprise an associate passing near a product shelf. If an area around the product shelf is geofenced, the triggering process may trigger a product inventory check to physically verify if it is time to refill a product in product shelf. Example timing information may comprise a time of day. A trigger may be disabled during off-hours, when an associate is on a break, and/or the like.

Event information may comprise one or more events in a sequence of events (e.g., immediately preceding events, last X number of events). Event information may comprise one or more locations in a sequence of locations (e.g., immediately preceding locations, last X number of locations). The triggering process may be configured to recognize a patterns of activities. The pattern may be learned by machine learning based on event information of a single user or event history of multiple users. Other user information may comprise information indicating the presence of other users (e.g., or user devices) within a threshold range of the user device. Other user information may comprise the event information (e.g., activities/locations) of the other users. A customer can tap on a product tag (e.g., or otherwise detect a trigger of the product, such as capture an image) and browse product specifications. This action may be used to cause a nearby employee to have information automatically sent indicating information about the product and/or the user (e.g., the user's location, purchase history, user category). Example business rules may comprise rules associated with an enterprise resource planning service (e.g., a business process management process) that trigger information delivery if the business rules are met.

Smart Responding

A service external to the user device (e.g., any service of the content platform 102 or otherwise described herein) may be configured based on a response process to respond or not respond to requests from a user device based on artificial intelligence, and/or other rules. The service may be configured to respond or not respond to requests automatically generated by the user device (e.g., or by a service external to the user device). The service may be configured to analyze context information to determine whether to respond or not respond. The context information may comprise user information or nearby users, event information (e.g., prior events, locations), and/or the like.

Modeling User Expertise

One or more models may be used to model a user profile (e.g., user experience level, user expertise). The one or more models may be based on a history of user interactions (e.g., with the user device, with the content platform). The one or more models may be based on user attributes, such as age, education, seniority, role, location, and/or the like. Conventional content recommendations are often based only on the user's current attributes. The one or more models may be configured evolve over time. As different users have different event history, over time user models associated with different users may diverge. For example, two similar associates with one-year work history may have very different levels of exposure to content, therefore one of them may be recommended more advanced content compared to the other user.

Recommending Content or Action Prompts

Recommended content may be provided to users (e.g., by the information service 120, the user interface service 122, the association service 708, the interface service 706). Action prompts may also be provided by users. The recommended content may be ranked according to predicted relevance. The recommend content and/or action prompts may be generated in response to user generated events, automatic triggers, and/or the like. The recommended content and/or action prompts may be determined (e.g., or generated) based on user experience profile, user attributes, user behaviors, user similarity to other users, physical content metadata provided with the trigger event, a combination thereof, and/or the like.

The recommended content and/or action prompt may comprise a suggested next activity and/or location to move to. If a delivery truck has arrived, an associate may be prompted to head to the receiving dock. A notification of the delivery truck arrival may be sent (e.g., by a user device, by a different triggering device) to the content platform 102, to the organization platform 106, or a combination thereof. The content platform 102 may determine to send information based on the notification. The organization platform 106 may process business logic triggering sending a message to the content platform 102 to send the recommended content and/or action prompt. (e.g., to user devices of users associated with unloading the truck). The business logic may comprise a rule that causes a first action to be triggered if a second action is detected. The business logic may comprise a plurality of actions and relationships (e.g., sequence between) between the actions. One or more of the actions may be associated with corresponding logic (e.g., computer-readable code) that triggers an action to be performed, such as sending a message, performing an analysis of stored information, updating a machine learning model, causing actuation of a device (e.g., door, audio alert), enable and/or disabling access rights, causing an inventory reorder, starting a maintenance request, and/or the like. The second action may be associated with a location. The first action may be based on the location of the second action. The first action may be associated with a category of users. Users having the category that are at the second location may be automatically determined. An information profile and/or other information may be sent to the users associated with performing the second action.

The recommended content and/or action prompt may comprise content assigned by supervisors/shared by colleagues. The recommend content may be a new memo, new instructions management wants to deliver to associates, an invitation to review the instructions, and/or the like.

The recommended content and/or action prompt may comprise content that is currently trending and/or popular. The trending and/or popular content may be specific to a user segment, such as a category, role, location. The recommended content could be a new training video that other users have been watching.

The recommended content and/or action prompt may be based on a business process shortcut (e.g., a computer implemented action that facilitates an action in a business process or business process map). Most activities users perform at a workplace are not random but are part of a certain business process. Business process may be associated with functions, devices, and/or the like that facilitate actions to perform the business process. Example business processes may comprise initiating an inventory reorder, starting a maintenance request, and/or the like. The types of business processes that could be initiated within the user's context (e.g., user role, event history, location) may be provided (e.g., as part of an information profile) to the user (e.g., as a shortcut). The content platform 102 may be configured to associate user information with corresponding business processes. A list of business processes (e.g., or business logic) may be received from the organization platform 106. The content platform 102 may be configured to learn and/or model which user information is relevant to which business processes. In some scenarios, the content platform 102 may query the organization platform 106 to determine which business processes are relevant to which user information. The recommended content and/or action prompt may be based on business rules, such as business rules from integrations with an ERP, to trigger content delivery when business rules are met. Actions performed on a user interface (e.g., searching for information) while one or more users are engaged in performing a task may be stored. The stored information may be used to build an information profile. Patterns in the stored information, such as navigating to a specific information module, querying a web page, and/or the like may be identified to determine the information for the information profile.

Relevance Feedback

Feedback may be used to determine the relevance of information sent to a user device. A user profile, recommendation model, and/or the like may be updated based on the feedback. The feedback may be determined based on user interaction with the user device. The feedback may be explicit (e.g., likes/dislikes), implicit (e.g., did the user open the recommended content, how long spent they spend exploring it, etc.), a combination thereof, and/or the like. Several recommendations may be given to a user to choose from (e.g., at the same time). The specific content the user selects can indicate that the content is relevant.

Recommender Inputs

A user profile (e.g., or user information, user model, current context) may be determined based on any combination of the following. The user profile may be based on user demographic attributes (e.g., age, gender, level of education, etc), user organization attributes (e.g., role, seniority, location, department, etc.), user experience level (e.g., this may be modeled separately based on the history of user actions, certifications, training, supervisor feedback, other accomplishments, etc.), user history of interactions (e.g., past triggers, actions, content access, etc.), user history of content fit feedback (e.g., past feedbacks a user has provided to the content recommended), other similar user behaviors (e.g., collaborative filtering, actions of other users who have a similar profile/demographics/interaction history), timing information (e.g., day of week, time of day, certain types of content can be more relevant during certain weekdays or time frames), user preceding sequence of interactions (e.g., immediately preceding sequence of user activities), a combination thereof, and/or the like.

The user profile may be based on direction of change in patterns/behaviors. It is expected that users may follow certain behavioral patterns as they perform their activities. However, these patterns may evolve overtime. For example, a forklift operator may need to read forklift operations manuals less and less frequently as their level of expertise increases over time. Therefore, it would be useful to understand the direction of these patterns change, to keep recommendations relevant and up-to-date.

The user profile may be based on sensor data, such as accelerometer/gyro and other sensors. The sensor data may be used to recognize what activity the user is performing and predict what is to be performed next. Example activities may comprise running, walking, lifting, operating a vehicle, operation a forklift, operation equipment, taking a break, sitting, performing a repetitive task, and/or the like. Sensor data from multiple on-device sensors may be used to recognize the type of activity the user is engaged within a workplace. For example, operating a forklift can have a specific signal signature in accelerometer data, gyroscope data, microphone data, and/or the like.

The user profile may be based on user information about other users in a threshold range of the user and these user's current activities (e.g., network effect). The recommender can recognize what other users in proximity are engaged with (e.g., associate/customer interaction, other associates gathering for an ad-hoc meeting, other associates are involved with truck unloading, etc.). If other users are gathering to a meeting place, information may be sent to the user about a meeting at the meeting place, an invitation to join the meeting, and/or the like.

The user profile may be based on recent device usage (e.g., other apps usage, screen time, battery level, etc.). The user profile may be based on business rules, such as integrations with ERP, etc, to trigger content delivery when business rules are met.

Association Service

FIG. 7 shows an example system for providing information. The system may comprise one or more of a user device 702, a management device 704, an interface service 706, an association service 708, content 710, integration service 712, business data 714, first data 716, second data 718, triggering features 720, a combination thereof, and/or the like.

The system 700 may be implemented by the system of FIG. 1 and/or the system of FIG. 2. The content platform 102 may comprise the association interface 706, the interface service 708, the content 710, the integration service 712, the business data 712, the first data 716, the second data 718, the triggering features 720, a combination thereof, and/or the like.

The interface service 706 may comprise a service configured to provide a user interface. The user interface service 122 of FIG. 1 may implement the interface service 706 of FIG. 7. The interface service 706 may configured to receive requests, from one or more of the user device 702 or the management device 704, for interface data. The interface data may comprise pages, resources, content (e.g., information modules, URIs for accessing information modules), and/or the like that is rendered by the user device 702 and/or the management device 704 as a user interface.

The user device 702 may be configured to capture (e.g., or scan) imaging data. The user device 702 may comprises one or more imaging sensors (e.g., or sensor array), such as a camera sensor, a LIDAR sensor, an infrared sensor, a RADAR sensor, a light sensor, or a combination thereof. The imaging data may comprise one or more of a video, an image, an infrared image, a LIDAR image, a RADAR image, an image comprising a projected pattern, a combination thereof, and/or the like. The imaging data may be captured based on an event, such as a user pressing a button, the user device receiving an interaction from a user, the user device entering an environment (e.g., premises, property, geo-fenced area, site), the user device being within range of a triggering feature 720, the user device being within a location range, an orientation of the user device, and/or the like. The dotted line between the user device 702 and the triggering feature 720 indicates detection and/or capture of the triggering feature 720 by the user device 702.

The user device 702 may be configured to process the imaging data. In some implementations, the interface service 706, association service 708, or other computing service (e.g., any computing service of content platform 102, an external third party service) may process the imaging data in addition to or alternative to the user device processing the imaging data.

One or more triggering features 720 may be determined based on the imaging data. Determining the one or more triggering features 720 may comprise receiving the imaging data from the user device 702 and processing the imaging data to determine the one or more triggering features 720. Determining the one or more triggering features 720 may comprise receiving, from the user device 720, data indicating the one or more triggering features 720. The user device 702 or an additional computing device (e.g., a third party image processing service) may process the imaging data to determine the one or more triggering features 720. The data indicating the one or more triggering features 720 may be processed and/or matched to associate the one or more corresponding features with corresponding assets, services, and/or the like.

The imaging data may be processed to determine one or more triggering features 720. The one or more triggering features 720 may comprise one or more of a pattern, a shape, a size, text information, a color, a symbol, a graphic, a bar code, or an identifier. The one or more triggering features may comprise an identifier of one or more of an asset, a price label, a sign, signage, a product, a shelf, a display, an aisle, an equipment, a workstation, or a service. The one or more triggering features 720 may comprise a stock keeping unit (SKU), a universal product code (UPC), and/or other identifier.

An image of a shelf of products may be captured and processed. Identifiers of the products may be determined by optical character recognition. The identifiers of all or some of the products on the shelf may be determined as one or more triggering features 720. Signage in the imaging data may be determined. The signage may have a corresponding identifier that may be determined. The signage may represent an area, such as a shelf, lane, aisle, product area, service area, and/or the like of the environment.

Determining the one or more triggering features 720 may comprise one or more of determining a plurality of triggering features 720, determining a pattern of triggering features 720, determining a plurality of feature vectors, identifying an object, inputting the imaging data into a machine learning model, performing optical character recognition, detecting a graphic, detecting a symbol, or determining that one or more characters indicate an identifier. One or more machine learning models may be trained to recognize assets in the environment (e.g., products or other assts at a store). An image of one or more of the assets may be captured. The resulting imaging data may be input into the one or more machine learning models (e.g., which may be accessed by the user device, the content platform 102, or the association service 701, and/or the like). The one or more machine learning models may output an indication (e.g., identifier, SKU, UPC) of the one or more assets and/or one or more services. In some scenarios, the one or more services may be determined based on the assets.

Processing the imaging data may comprise detecting one or more features in the environment and matching the one or more features to an identifier of one or more of an asset, a product, an object, a service, a physical location, or a virtual location. The imaging data may be processed using one or more asset processing rules (e.g., or asset pattern recognition rules). The asset processing rules may match a shape and/or combination of shapes, lines, curves, size, orientations, images, colors, and/or the like with corresponding assets. For example, basic box shapes may be associated with some assets (e.g., boxed products) while other more complex shapes may be associated with other assets (e.g., unboxed tools, parts).

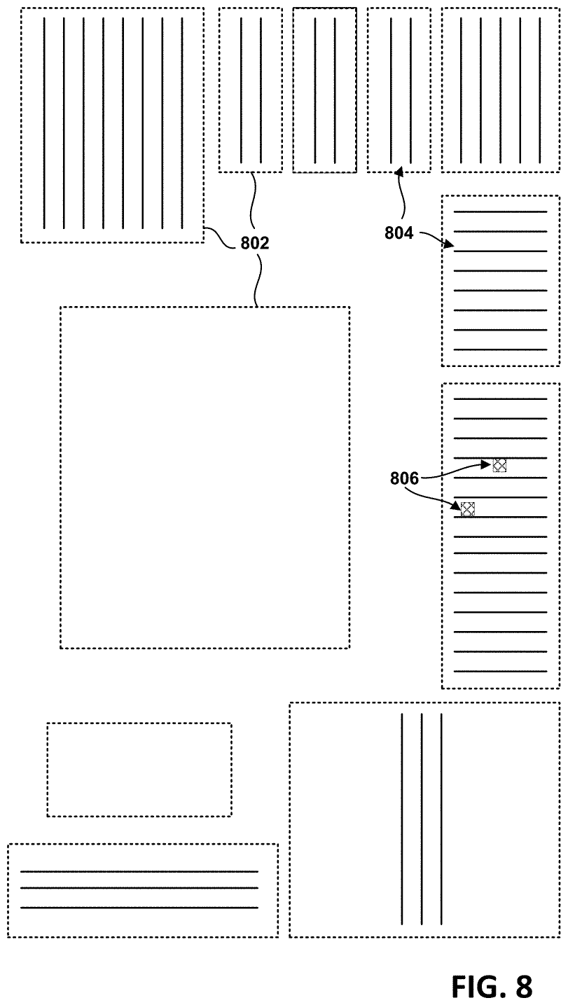

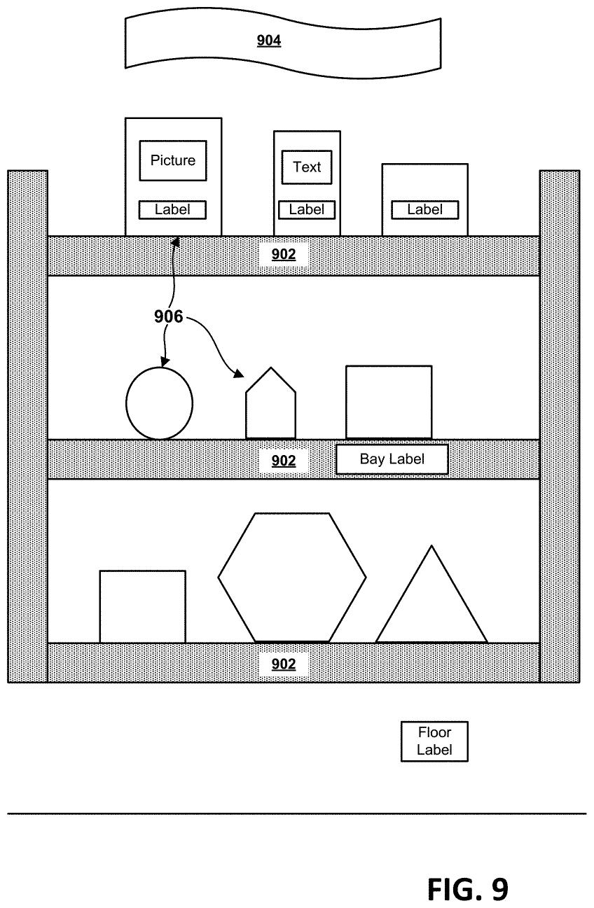

The association service 708 may be configured to determine (e.g., generate, store, access) associations between triggering features 720, locations, content, services, and/or the like. The associations may be determined based on analysis of first data 716 and/or second data 718. The first data 716 may comprises data indicative of location areas within the environment, such the shelf, aisle, bay, lane, pallet location, product area, service area, and/or the like. An example of the first data 716 is shown in FIG. 9. The second data 718 may comprise data indicative of an environment (e.g., premises, property, geo-fenced area, site), such as a store map. The data indicative of the environment may comprise a store layout indicating a plurality of location areas, as shown in FIG. 8. The location areas may be associated with corresponding portions of the first data. For example, data for a particular shelf may be stored in the first data 716. A location of the particular shelf may be stored in the second data 718. In some scenarios, the first data 716 and the second data 718 may be stored as one integrated data store.

A computer implemented association process (e.g., of the association service 708) may be configured to determine the associations between triggering features 720, locations, content, services, and/or the like. The association process may analyze the first data 716 and/or the 718 to identify (e.g., automatically identify) one or more triggering features 720. The first data may comprise a graphical representation of placement of assets in a location area. The graphical representation may be processed to identify triggering features 720 indicative of the assets, such as identifiers (e.g., SKU, UPC), shape, size, color, orientations, location (e.g., within the location area), and/or the like. The graphical representation may comprise signage, shelfing, structures, and/or the like. The signage, shelfing, structures, and/or the like in the graphical representation may be processed to identify triggering features 720 indicative of the signage, shelfing, structures, and/or the like. The triggering features 720 indicative of the shelfing, structures, and/or the like may be associated with assets.

The association process may comprise a rule-based process, a pattern recognition process, predictive modeling process, a machine learning process, or a combination thereof. The association process may be based on one or more machine learning models that output triggering features 720 for identifying assets, signage, shelving, structures, location areas, equipment, and/or the like. The association process may automatically update the triggering features 720 as changes occur in the first data 716 and/or the second data 718. The association process may be further trained by receiving feedback on predicted associations between assets, services, and/or the like and corresponding triggering features 720, locations, and/or the like.

The associations between triggering features 720, locations, content, services, and/or the like may be determined based on user input. The management device 704 may be configured to input associations between triggering features 720, locations, content (e.g., information modules), and/or the like. The interface service 706 may cause a representation of the environment (a schematic, map, diagram, floor plan, layout, site layout) to be output via the management device 704. The representation of the environment may comprise the second data 718 or a rendering of the second data 718. A user may use the representation of the environment to associate a triggering feature 720 with corresponding location information (e.g., spatial information), timing information (e.g., date, time, time of day), service information (e.g., employee service functions), user information (e.g., information modules), and/or the like. The representation of the environment may allow the user to access additional representations (e.g., planograms) of areas within the environment, such as a shelf, aisle, bay, lane, product area, service area, and/or the like. The areas within the environment may be associated with corresponding assets, services, and/or the like. The user may add, remove, update, and/or the like the assets, services, and/or the like. The user may associate the assets, services, and/or the like with corresponding locations within the location area. The user may associate the assets, services, and/or the like with corresponding triggering features 720.

The association service 708 may be configured to process requests for an inferred location. The inferred location may comprise a location that a user device (e.g., or a user) is predicted (e.g., or determined, inferred) to be within the environment. The request may comprise one or more imaging data. The association service 708 may process the imaging data to determine the one or more triggering features 720. The request may comprise data indicating the one or more triggering features 720 (e.g., identified by the user device 702). The data indicating the one or more triggering features may be processed to determine any matching triggering features 720 stored by the association service 708. The determined triggering feature 720 may be associated with an asset. The inferred location may be determined based on a location area (e.g., shelf, aisle, bay, lane) associated with the asset. The determined triggering feature 720 may be associated with signage. The inferred location may be determined based on spatial data associating the triggering feature 720 with a location of the environment. The spatial data may comprise a location area (e.g., shelf, aisle, bay, lane, dock, door). The spatial data may comprise a spatial coordinate associated with the environment.

The inferred location may be determined based on sensor data, location inference rules, pattern recognition, a machine learning model, or a combination thereof. The sensor data may comprise data from an accelerometer, a proximity sensor, an infrared sensor, a light sensor, a near field sensor, a global positioning sensor, a gyroscope, a temperature sensor, or a barometer. The user device 702 may send the sensor data with the imaging data and/or the data indicating the one or more triggering features 720. The sensor data may comprise depth information that may be used (e.g., by a machine learning model) for object recognition. The sensor data may comprise location information and/or signal data used for triangulation of a location, such as such as wireless signals, satellite signals, Bluetooth signals, and/or ultrawide band signals. The location information and/or signal data may be used to increase precision of the inferred location. For example, the location information and/or signal information may be used to infer a distance of the user device 702 from an asset associated with a triggering feature 720, a specific location within a location area, and/or the like.

The inferred location may be determined based on one or more of the triggering features 720, the first data 716, the second data 718, an association thereof, a combination thereof, and/or the like. The inferred location may be determined based a triggering feature 720, location information associated with the environment, an association of a triggering feature 720 and location information, and/or the like. The location information associated with the environment may comprise one or more of spatial information of a premises, layout information of a premises, aisle information of a premises, signage information of a premises, or rack information of a premises.

The association of a triggering feature 720 and location information (e.g., a location area, placement within the location area) may be stored and/or accessed in one or more of a premises map, a planogram, or an association map associating one or more features (e.g., triggering features) and/or symbols (e.g., identifiers) with corresponding locations. The association of the triggering feature 720 and the location information may be one or more of input or updated by a user via one or more of a premises map, a shelf map, or an aisle map. The association with the triggering feature 720 and the location information may be one or more of determined by a computing device or updated by the computing device. The association may be determined based on an event detected by the computing device. The event detected by the computing device may comprise detection of a change in a planogram, detection of a change in a placement of an asset, or detection of a change in a feature associated with asset.

The first data 716 may be determined (e.g., accessed). The first data 716 may associate triggering features 720 with corresponding locations within a location area (e.g., a display, a shelf, aisle, bay, door, dock, department). The first data 718 may associate triggering features 720 with locations on a planogram. The second data 718 may be determined. The second data 718 may associate the first data 716 with a corresponding location of the environment (e.g., a premises). A triggering feature 720 determined from the imaging data may be used to determine an asset. The inferred location may be determined to be a location in the first data 718, such as a specific location within a location area (e.g., a location in a planogram). The inferred location may be determined based on the second data 718. The second data 718 may indicate a location within an environment in which a location area resides. The location within the environment may be the inferred location. The inferred location may comprise an inferred orientation within the environment (e.g., oriented toward the location area). The inferred location may comprise a location range, such as a three-dimensional or two-dimensional spatial range. The inferred location may comprise timing information, such as a time associated with a physical location.

The inferred location may be determined based on a plurality of triggering features 720 (e.g., detected in the imaging data). The location inference rule may comprise a rule indicating the inferred location if a threshold number of the plurality of triggering features are associated with the inferred location. The inferred location may be determined, based on a pattern of least a portion of the plurality of triggering features 720 being detected in the same imaging data, the inferred location.

The inferred location may comprise a physical location associated with the environment. The inferred location may comprise one or more of a location at a premises, a premises zone, a location associated with a shelf, a location associated with an aisle, a location associated with a department, a location associated with an asset category, a location associated with an asset grouping, a location associated with a service, a location associated with structure, a location associated with a store front, a location associated with a lane, a location associated with a door, a location associated with a bay, or a combination thereof.

The inferred location may comprise a virtual location representing a physical location of the environment. The inferred location may comprise one or more of a virtual location, a location in a virtual environment representing a physical environment, a location scope defining an area within a range of the user device, a multidimensional location context associating spatial information with one or more of triggering features 720 and information modules, or a multidimensional location context associating a range of spatial locations with at least one of an asset, an information module, or a triggering feature 720. In some scenarios, the environment may comprise a virtual environment, such as one navigated by a browser, one navigated by a virtual reality headset or other navigation device and/or application. In such scenario, the imaging data may comprise an image of a page, an image of a three-dimensional representation of the environment, and/or the like. The virtual environment may be hosted and/or managed by a different entity than the entity that manages and/or hosts the content platform 102.

The association service 708 may be configured to determine an information profile. The information profile may be determined based on the inferred location, user information (e.g., user account, user history, role, skill level, certification) associated with the user device 702, or a combination thereof. The information profile may be determined according to any of the techniques described herein, such as using rules, pattern recognition, machine learning models, and/or the like. The association service 708 (e.g., or interface service 706) may be configured to send a request to the information service 120 of the content platform 102 of FIG. 1. The information profile may be determined, generated, and/or the like by the information service 120. The user information, the inferred location, asset information associated with the triggering features 720, and/or the like may be sent to the information service 120 for use in determining the information profile. In some scenarios, the information service 120 may be integrated into the association service 708.

The information profile may comprise information associated with an asset (e.g., or service) at the inferred location. The information associated with the asset (e.g., or service) at the inferred location may comprise one or more of: task information, certification information, job function, skill information, an owner's manual, rental information, pricing information, training, instructional information, product safety information, product attachment information, accessory information, professional instruction and use content for the asset, a project planner for a project using a product, or product maintenance information.

Determining the information profile may comprise determining (e.g., selecting, ranking) one or more information modules from a plurality of information modules. The one or more information modules may be one or more of selected, ranked, filtered, or output based on an association of the one or more information modules with the inferred location. The one or more information modules may be one or more of selected, ranked, filtered, or output based on an association of the one or more information modules with at least a portion of the user information. Information modules that are predicted to be the most relevant to the triggering feature 720, asset, and/or location may be ranked above other information modules. Determining the information profile may comprise determining specific information to add and/or remove from an information module (e.g., to customize the information for a specific user).

An example information module may comprise an asset information module that provides information about a specific asset. If the user is a customer, the asset information module may comprise pricing information, purchase options, basic product details, related products, and/or the like. If the user is an employee, the asset information may comprise reordering information, advanced technical details (e.g., maintenance, product manual), common questions and answers, product stock count, sales targets, promotions, and/or the like. If the user is an employee, additional information modules may be provided that are not available to the user, such as a location area (e.g., department, aisle, zone) information module with general information (e.g., and common issues, customer questions) specific to the location area. If the user is a manager, the additional information module may be provide profitability information, sales numbers, employee assignments associated with the location, and/or other information.

The information profile may comprise a plurality of information modules associated with a plurality of assets within viewing range of the inferred location. Each module may have a separate information module. A single information module may comprise information about a plurality of assets. The information profile may comprise a plurality of information modules associated with a plurality of assets within a threshold range of the inferred location. The information profile may comprise information related to a triggering feature 720, asset associated with the triggering feature 720, and/or the like. The information profile may comprise a first information module associated with a first asset associated with a triggering feature of one or more triggering features 720. The information profile may comprise a second information module associated with a second asset. The second information module may be included in the information profile based on an association of the second asset with one or more of the first asset or the user information.

The user information may comprise user information determined by the profile service 114 of the content platform 102 of FIG. 1. The user information may comprise any information tracked and/or stored by the profile service 114. Specific portions of the user information (e.g., or a general identifier of the user account) may be provided to the information service 120 and/or the association service 708. The user information may comprise any user information described herein. The user information may comprise one or more of a user name, a user identifier, a user type, a user role, a user function, a user affiliation, a user employer, a user team, or a user organization. The user information may comprise one or more of an experience level, an achievement level, a certification level, or a skill level. One or more of the experience level, the achievement level, or the skill level may be updated based on one or more of an event, a predetermined number of events associated with a user of the user device, a history of events, a user role, or a user training level.

If the imaging data shows products related to a dairy aisle (e.g., or more specifically a milk rack), the information module may comprise information about the dairy products (e.g., expiration dates, related products, sales, promotions, chain of custody, company information, recipes). If the user information indicates that the user of the user device is an employee that stocks the dairy products, the information module may comprise restocking information, cleaning information, information for identifying expired products, and/or the like. If the user information indicates that the user is a service technician, the information module may comprise a service history for a refrigerator, parts information for the refrigerator, a manual for the refrigerator, and/or the like.

If the imaging data shows triggering features 720 related to a warehouse aisle, the information module (e.g., or information profile) may comprise supply chain information, product data, shipping data, training data, and/or the like.

The content 710 may comprise content associated with the interface service 706. The content 710 may comprise text, documents, pages, images, videos for providing a user interface. The content 710 may comprise content for generating and/or populating an information module.

The integration service 712 may be configured to communicate with external services. The integration service 712 may comprise an application programming interface (e.g., a set of accessible functions) for communicating with the association service 708, the interface service 706, and/or the like. Applications managed by an organization external to the content platform 102 of FIG. 1 may access the association service 708, the interface service 706, and/or the like via the integration service 712. The integration service 712 may comprise the integration service 124 of FIG. 1.

The business data 714 may comprise real time data, historical data, financial data, sales data, training and certification data, operational data, workforce data, employee data, customer data, asset data, maintenance data, a combination thereof, and/or the like. The business data 714 may be used to determine user information, such as to build a user profile, user model, and/or the like. The business data 714 may provided as part of an information profile, information module, and/or the like.

FIG. 8 shows an example of location information represented as a layout of an environment. The location information may comprise and/or be represented as map of the environment, such as a map of a premises. The location information may comprise a plurality of zones 802, which are shown as dotted lines. Each zone may correspond to a department, and/or a department may comprise one or more zones. A zone may comprise a plurality of aisles 804 (e.g., or lanes), which are shown ad solid line rows. An environment, zone, and/or aisle may comprise one or more location areas 806 (e.g., two location areas are shown but it should be understood that many more location areas may be used). Location areas may have different sizes and shapes dependent on a variety of factors and design requirements. A location area may comprise an area around (e.g., or on, within) a rack, a subsection of an aisle, and/or any arbitrary area tracked by the location information.

FIG. 9 shows another example of location information represented as a planogram of a rack. The location information shows a location area, such as a location area in an aisle or zone. The location information may indicate specific shelves 902 within a location area. The location information may indicate signage 904. The signage 904 may indicate an asset category or other similar information. The location information may indicate locations of assets 906 within the location area. The assets 906 may have a variety of shapes, colors, sizes, and/or the like. An asset 906 may comprise text, a picture, a label (e.g., identifier, UPC, SKU), and/or the like. The shapes, colors, sizes, text, pictures, labels, arrangement with respect to neighboring assets, location on a shelf, location within a rack, or a combination thereof may be identified as a triggering feature associated with one or more of an asset, a grouping of assets, a shelf, a location area, a location in the environment, and/or the like. Additional environment features may be identified as triggering features. The environment features may comprise wall features, door features, equipment (e.g., forklifts) features, structure features, furniture, arrangements thereof, a combination thereof, and/or the like may be identified as triggering features.

A user device and/or other computing device may image, scan, and/or the like the location area to identify the triggering features. A management device may image, scan, and/or the like the location area to identify triggering features. Potential triggering features and corresponding assets, shelfs, location area, location in the environment may be stored and provided to a user (e.g., manager, employee) for input. The user may approve (e.g., or reject) the proposed triggering feature as identifying corresponding assets, shelfs, location area, location in the environment. A user device may later on scan the location area and receive an information profile relevant to the location area, an asset, user information, and/or the like.

Additional location areas may be indicated by floor labels, bay labels, and/or the like. A shelf 902 may comprise multiple bays. Each bay may be associated with a different asset. A floor label and/or bay label may comprise a symbol, identifier, tag (e.g., NFC tag). The floor labels, bay labels, and/or the like may be potential triggering features. An inferred location may comprise a location associated with a floor label, bay label, and/or the like. Imaging data may be analyzed to recognize a combination of triggering features including floor labels, bay labels, pictures, text, shapes, identifiers, symbols, and/or the like.

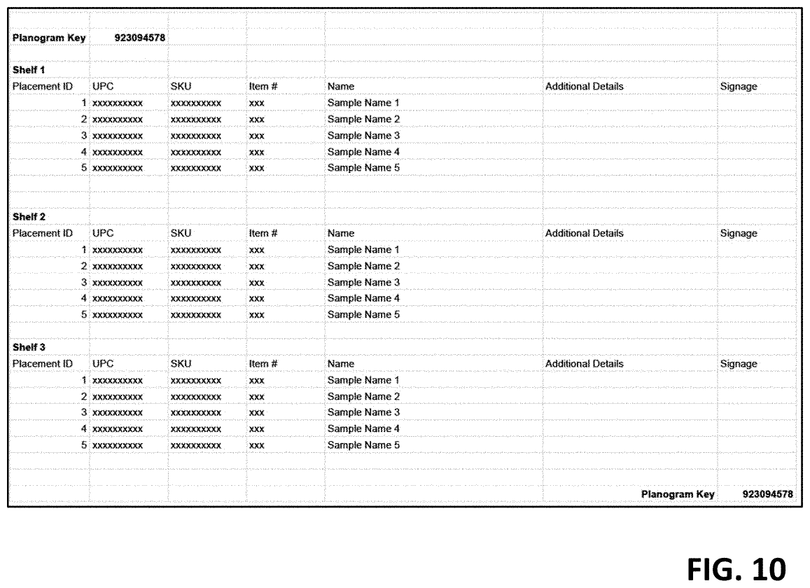

FIG. 10 shows another example of location information represented in a data structure. The location information may indicate the assets on the different shelves of FIG. 9. The location information may indicate shelf placement of corresponding assets. Information associated with the assets, such as UPC, SKU, item number, name, and/or other details may be stored in the location information. The information associated with the assets may be used as triggering features for identifying an inferred location. A SKU, UPC, item number, asset name, signage, and/or other details determined by processing an image of a location area may be compared to the SKU, UPC, item number, asset name, signage, and/or other details stored in (e.g., or associated with) the location information.

If triggering features from the imaging data match the information associated with the assets for a top shelf but not a middle or bottom shelf, then the inferred location may comprise the top shelf of the location area. If triggering features from the imaging data match the information associated with the assets of the top, middle, and bottom shelf (e.g., or match a threshold number from each shelf), then the inferred location may comprise the entire rack and/or location area. If triggering features match assets from multiple racks in an aisle, then the inferred location may comprise the aisle.

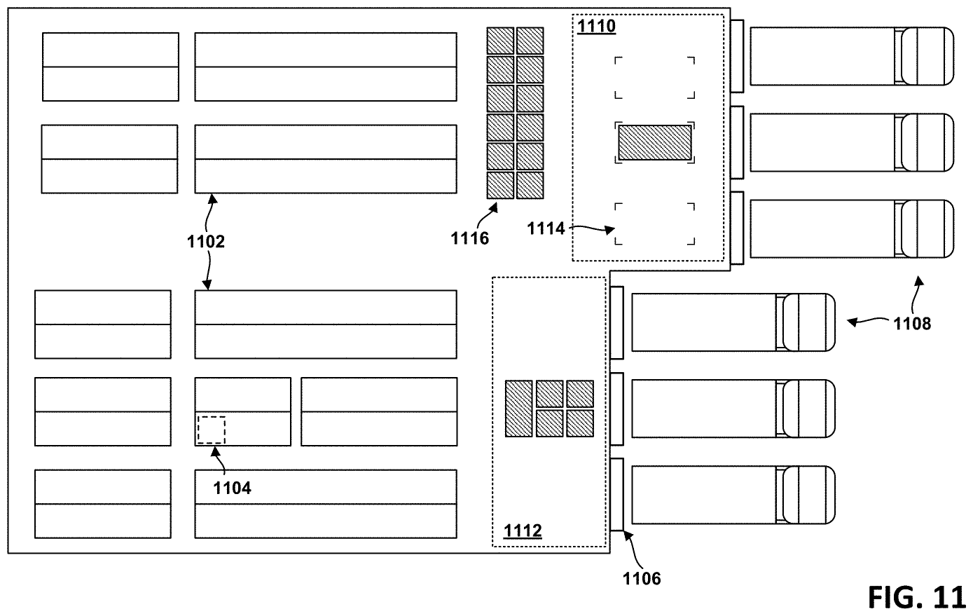

FIG. 11 shows an example of location information represented as a layout of an environment. The environment (e.g., or premises) may comprise a warehouse. Example assets of the environment are shown in cross hatching. The environment may comprise a plurality of aisles 1102. The plurality of aisles 1102 may comprise aisles indicated by markings on a floor, aisles formed by structures (e.g., shelving), or a combination thereof. The plurality of aisles 1102 may comprise one or more subsections 1104. A subsection 1104 may be used to store a particular asset. A subsection 1104 may indicated by an identifier, symbol, barcode, tag, UPC, SKU, and/or the like. A subsection 1104 may correspond to a location on a shelf, a marked location on the floor, a bay, a pallet, and/or the like.

The environment may comprise a plurality of docks 1106. Vehicles 1108 may be positioned next to the plurality of docks 1106 for loading and unloading of assets. The environment may comprise a loading area 1110, an unloading area 1112, and/or the like. The loading area 1110 and unloading area 1112 may be next to corresponding docks of the plurality of docks. The loading area 1110 and/or unloading area 1112 may comprise one or more marked areas 1114. A marked area 1114 may include indicate where an asset is placed before or after unloading or loading. The environment may also comprise a transition area 1116 in which assets may be stored temporarily (e.g., before loading, before placement in an aisle 1102.

Activities (e.g., events, actions, locations) of users may be tracked while the user is in the environment (e.g., premises, site, job site). Information may be sent to user devices based on activation of a trigger. Activation of a trigger may comprise a user scanning a tag, capturing an image, sending a request, entering an area, being within close range of a tag (e.g. NFC tag), business logic, and/or the like. Triggering features, actions to perform, assets, and/or the like may be associated with corresponding location areas, such as an aisle 1102, a subsection 1104, a dock 1106, a vehicle 1108, a loading area 1110, an unloading area 1112, a marked area 1114, or a transition area.

If a vehicle 1108 is detected at a dock 1106, activation of a trigger may be detected. The vehicle 1108 may be detected in imaging data captured by a user device or a device stationed in the environment. Users who are responsible for unloading the truck may be sent information indication an action to move to the unloading area 1112 and/or to unload the truck 1108. A user may indicate on their user device that the action is completed. This indication of completion may trigger sending additional information. The additional information may comprise a proposed next action to complete. The next action may be to move the assets from the transition area 1116 to different location areas in the aisles 1102. The user may move to the transition area 1116.

The user may scan a tag, capture an image, enter a geofenced area or otherwise trigger a request for information. An information profile may be sent to the user device to assist in placement of the assets. The information may profile may indicate a plan for efficiently placing the assets. It may be determined that the user is permitted to use equipment to move the assets. Based on this determination, an information module comprising instructions for operating the equipment may be provided as part of the information profile. An experience level associated with operating the equipment may be used to customize the information module (e.g., the user may be required to certify that they reviewed safety information if they have a lower experience level).

An inferred location of the user device may be determined at various points of the user's activity as explained in further detail herein. The inferred location can be any of the location areas shown in FIG. 11. The inferred location may be used to determine a specific information profile as described further herein.

The present application may be directed at least to the following aspects. Any of the numbered aspects below or a portion of a numbered aspect below may be combined with any other numbered aspect or a portion thereof. Any of the numbered aspects below may be combined with any aspect of multiple aspects described throughout the present disclosure and shown in the figures.

Aspect 1. A method comprising, consisting of, consisting essentially of, or comprising one or more of: receiving, from a user device, a request comprising data indicative of a location of the user device (e.g., or determining the data indicative of the location, e.g., with or without a request); determining, based on receiving the request, user information associated with a user of the user device; generating (e.g., or determining), based on the user information and the data indicative of the location, an information profile (e.g., an information profile relevant to a context of the user at the location); and transmitting, to th\e user device, the information profile.

Aspect 2. The method of Aspect 1, wherein the request is generated in response to the user interacting with a trigger (e.g., or triggering feature) associated with one or more the location, a service, or an asset.

Aspect 3. The method of Aspect 2, wherein interacting with the trigger occurs via at least one of: scanning a trigger, photographing the trigger, or causing the mobile device to be within a predetermined communication range of the trigger.

Aspect 4. The method of Aspect 2, wherein the trigger is one of: a near-field communication (NFC) tag, a radio-frequency identification (RFID) tag, a Quick Response (QR) Code, or a barcode, a beacon and/or the like.

Aspect 5. The method of any one of Aspects 1-4, wherein the data indicative of the location comprises data generated based on a positioning system of the user device, wherein the positioning system comprises one or more of a video positioning system, global positioning system, a wireless signal positioning system, an ultrawide band positioning system, a sound based positioning system, a beacon based positioning system, a Bluetooth beacon positioning system, an inertial positioning system, an accelerometer, or a device or tag that indicates the location.

Aspect 6. The method of any one of Aspects 1-5, further comprising determining, based on the data indicative of the location, an asset at the location, wherein the information profile provides one or more actions or information related to the asset, service, or location.

Aspect 7. The method of any one of Aspects 1-6, wherein the user information comprises one or more of a user name, a user identifier, a user type, a user role, a user function, a user affiliation, a user employer, a user team, or a user organization.

Aspect 8. The method of Aspect 7, wherein the user type is a customer or an employee.

Aspect 9. The method of Aspect 8, wherein the information profile is based on a trigger being associated with a service or asset and the user type being an employee, and wherein the information profile comprises information associated with one or more of installing, operating, managing, maintaining, training, or selling one or more of the service or asset.

Aspect 10. The method of any one of Aspects 7-9, wherein the information profile is one or more of generated or determined (e.g., collected, updated, curated) based on the user type.

Aspect 11. The method of any one of Aspects 1-10, wherein the location information comprises one or more of an asset location at a premises, a premises location (e.g., location of the premises, location within the premises), a global positioning coordinate, a geospatial location within a premises, a location history, a shelf location, a premises zone, a container, an aisle, a department of a premises, a location range, or a tagged location.

Aspect 12. The method of any one of Aspects 1-11, further comprising determining service information based one or more of the data indicative of the location, the request, or the user information.

Aspect 13. The method of Aspect 12, wherein the service information comprises a service associated with an asset at the location, a service for the user to perform, a service for the user to access, a prior service associated with the location, a service predicted to be relevant to the user, a sales service, a maintenance service, an installation service, a service of operating an asset, an informational service, or a service for a customer.

Aspect 14. The method of any one of Aspects 1-13, wherein the user information comprises one or more of an experience level, an achievement level, or a skill level.

Aspect 15. The method of Aspect 14, wherein the information profile is one or more of generated or determined (e.g., curated, collected, updated) based on one or more the experience level, the achievement level, or the skill level.

Aspect 16. The method of any one of Aspects 14-15, wherein one or more of the experience level, the achievement level, or the skill level is updated based on one or more of an event, a predetermined number of events associated with the user, a history of events, a user role, or a user training level.

Aspect 17. The method of Aspect 16, wherein the event comprises one or more of: using a product, using a comparable product, attending demonstrations associated with the product, renting the product, renting a comparable product, completion of in-person product training, or completion of on-line product training.

Aspect 18. The method of any one of Aspects 16-17, wherein the event comprises one or more of: using a service, using a comparable service, attending demonstrations associated with the service, renting the service, renting a comparable service, completion of in-person training, or completion of on-line training.

Aspect 19. The method of any one of Aspects 16-18, wherein the event comprises one or more of: using an asset, using a comparable asset, attending demonstrations associated with the asset, renting the asset, renting a comparable asset, completion of in-person asset training, or completion of on-line asset training.

Aspect 20. The method of any one of Aspects 1-19, wherein the information profile comprises information associated with an asset at the location, wherein the information associated with the asset at the location comprises one or more of: an owner's manual, rental information, pricing information, training, instructional information, product safety information, product attachment information, accessory information, professional instruction and use content for the asset, a project planner for a project using a product, or product maintenance information.

Aspect 21. The method of Aspect 20, wherein the rental information comprises one or more of a rental history for the product, rental availability for the product, return time, or rental fees.

Aspect 22. The method of any one of Aspects 1-21, further comprising receiving an additional request to rent a product from the user via the user device.

Aspect 23. The method of any one of Aspects 1-22, further comprising: receiving a request to purchase one or more of a product or a service from the user; and/or conducting a sales transaction to purchase one of more of the product or the service via the user device.

Aspect 24. The method of any one of Aspects 1-23, further comprising storing a history of events associated with the user, wherein one or more of the events are associated with one or more of the location, a corresponding action performed at the location, or a corresponding asset at the location.

Aspect 25. The method of Aspect 24, further comprising determining a pattern based on the history of events, wherein the pattern is determined based on one or more of the history of events associated with the user or a history of events associated with a plurality of users.

Aspect 26. The method of Aspect 25, wherein the information profile comprises information selected for the information profile based on the pattern.

Aspect 27. The method of any one of Aspects 1-26, wherein generating, based on the user information and the data indicative of the location, the information profile relevant to the context of the user at the location comprises selecting one or more information modules from a plurality of modules.

Aspect 28. The method of Aspect 27, wherein different information modules are selected for the information profile based on one or more of the location or an experience level associated with the user.

Aspect 29. The method of any one of Aspects 27-28, further comprising generating one or more models configured to predict relevance of an information module to a context, wherein the one or more information modules are selected based on the one or more models.

Aspect 30. The method of Aspect 29, wherein the context comprises one or more of a location characteristic, a user characteristic, or an asset characteristic of an asset at the location.

Aspect 31. The method of Aspect 30, wherein the user characteristic comprises one or more of a user role, a user experience level, a prior event associated with a user, a user permission level, or occurrence of a set of events being associated with a user.

Aspect 32. The method of any one of Aspects 30-31, wherein the asset characteristic comprises a prior event associated with the asset, a skill level associated with the asset, a scheduled event associated with the asset, an action associated with managing the asset, an asset category, or an asset price.

Aspect 33. The method of any one of Aspects 30-32, wherein the location characteristic comprises a location identifier, a location category, a location within a premises, a shelf location, or a geographic boundary.

Aspect 34. The method of any one of Aspects 29-33, further comprising tracking one or more interactions of the user with the information profile and training the one or more models based on the one or more interactions.

Aspect 35. The method of any one of Aspects 1-34, wherein the information profile comprises know how for performing an action associated with an asset or service at the location.

Aspect 36. A method comprising, consisting of, consisting essentially of, or comprising one or more of: determining a triggering event associated with an environment; determining, based on triggering event, user information and data indicative of a location of a user device associated the environment; generating, based on the user information and the data indicative of the location, an information profile relevant to a context of a user at the location; and transmitting, to the user device, the information profile.

Aspect 37. The method of Aspect 36, wherein determining the triggering event comprises receiving a request comprising the data indicative of the location of the user device.

Aspect 38. The method of Aspect 37, wherein the request is triggered based on one or more of a user scanning a location tag, capturing imaging data of the environment, capturing sensor data associated with the user device, or determining that a triggering rule is satisfied.

Aspect 39. The method of any one of Aspects 36-38, wherein determining the triggering event comprises one or more of determining one or more of a presence of user device in an geofenced area, a time frame associated with the triggering event, a sequence of events associated with the user device, a sequence of locations associated with the user device, a pattern of activities associated with the user device, or activity of one or more other user devices within a threshold range of the user device.

Aspect 40. The method of any one of Aspects 36-39, wherein determining the triggering event comprises determining that a rule associated with a business process is satisfied.

Aspect 41. The method of Aspect 40, wherein the rule indicates performance of a first action if a second action is completed, and wherein the information profile comprises a request to perform the first action.

Aspect 42. The method of Aspect 40, wherein determining that the rule associated with the business process comprises receiving a notification from a business process service configured to receive data and evaluate the rule based on the data.

Aspect 43. The method of any one of Aspects 36-42, further comprising determining an additional triggering event and determining to ignore the additional triggering event based on one or more of timing information, the user information associated with the user device, event information associated with the user device, or information associated with one or more additional devices located in the environment.

Aspect 44. The method of any one of Aspects 36-43, wherein determining the triggering event comprises determining, by a computing device external to the user device, the triggering event.

Aspect 45. The method of any one of Aspects 36-44, wherein determining the triggering event comprises receiving an indication of the triggering event from the user device.

Aspect 46. The method of any one of Aspects 36-45, wherein the user information indicates changes over time in one or more of a skill, a user role, a user experience level, or a user expertise level.

Aspect 47. The method of any one of Aspects 36-46, wherein the information profile comprise information ranked based on relevance to the user.

Aspect 48. The method of any one of Aspects 36-47, further comprising receiving data indicating user feedback associated with the information profile and updating a user model based on the user feedback, wherein the user feedback comprise one or more of a like, dislike, selecting information in the information profile, an amount of time spent accessing information in the information profile, or ignoring information in the information profile.

Aspect 49. The method of any one of Aspects 36-48, wherein the user information comprises a sequence of events within a threshold time period preceding the triggering event, and wherein the information profile is based on the sequence of events.

Aspect 50. The method of any one of Aspects 36-49, wherein determining the triggering event comprises determining sensor data from one or more sensors of the user device, determining that the sensor data indicates an inferred action performed by a user, and determining that the inferred action matches the triggering event.

Aspect 51. The method of Aspect 50, wherein the one or more sensors comprise an accelerometer, a gyroscope, a light sensor, a proximity sensor, a positioning sensor, or a microphone.

Aspect 52. The method of any one of Aspects 50-51, wherein the inferred action performed by the user comprises performing an operation associated with sensor data signature, operating equipment in the environment, not operating equipment, falling down, talking, walking, resting, lifting an asset, accessing the user device, or running.

Aspect 53. A method comprising, consisting of, consisting essentially of, or comprising one or more of: determining, based on data associated with a user device, one or more triggering features, wherein the one or more triggering features are features associated with processing imaging data comprising one or more images of an environment in which the user device is located; determining, based on an association of the one or more triggering features and location information associated with the environment, an inferred location of the user device in the environment; determining, based on the inferred location and user information associated with the user device, an information profile; and causing the information profile to be output via the user device.

Aspect 54. The method of Aspect 53, wherein determining the one or more triggering features comprises receiving the imaging data from the user device and processing the imaging data to determine the one or more triggering features.

Aspect 55. The method of any one of Aspects 53-54, wherein determining the one or more triggering features comprises receiving, from the user device, data indicating the one or more triggering features, wherein the user device or an additional computing device processes the imaging data to determine the one or more triggering features.

Aspect 56. The method of any one of Aspects 53-55, wherein the one or more triggering features comprises one or more of a pattern, a shape, a size, text information, a color, a symbol, a graphic, a bar code, or an identifier.

Aspect 57. The method of any one of Aspects 53-56, wherein the one or more triggering features comprises an identifier of one or more of an asset, a price label, a sign, signage, a product, a shelf, a display, an aisle, an equipment, a workstation, or a service.

Aspect 58. The method of any one of Aspects 53-57, wherein the imaging data comprise one or more of a video, an image, an infrared image, a LIDAR image, a RADAR image, or an image comprising a projected pattern.

Aspect 59. The method of any one of Aspects 53-58, wherein determining the one or more triggering features comprises one or more of determining a plurality of triggering features, determining a pattern of triggering features, determining a plurality of feature vectors, identifying an object, inputting the imaging data into a machine learning model, performing optical character recognition, detecting a graphic, detecting a symbol, or determining that one or more characters indicate an identifier.

Aspect 60. The method of any one of Aspects 53-59, wherein determining the imaging data comprises detecting one or more features in the environment and matching the one or more features to an identifier of one or more of an asset, a product, an object, a service, a physical location, or a virtual location.

Aspect 61. The method of any one of Aspects 53-60, wherein determining, based on the association of the one or more triggering features and the location information, the inferred location associated with the user device comprises determining the inferred location based on one or more of sensor data, a location inference rule, pattern recognition, or a machine learning model.

Aspect 62. The method of Aspect 61, wherein the sensor data comprises data from an accelerometer, a proximity sensor, an infrared sensor, a light sensor, a near field sensor, a global positioning sensor, a gyroscope, a temperature sensor, or a barometer.

Aspect 63. The method of any one of Aspects 61-62, wherein the location inference rule comprises a rule indicating the inferred location if a threshold number of the one or more triggering features are associated with the inferred location.

Aspect 64. The method of any one of Aspects 53-63, wherein the one or more triggering features comprises a plurality of triggering features, and wherein determining the inferred location comprises determining, based on a pattern of least a portion of the plurality of triggering features being detected in the same imaging data, the inferred location.

Aspect 65. The method of any one of Aspects 53-64, wherein the inferred location comprises one or more of a location at a premises, a premises zone, a location associated with a shelf, a location associated with an aisle, a location associated with a department, a location associated with an asset category, a location associated with an asset grouping, a location associated with a service, a location associated with structure, or a location associated with a store front.

Aspect 66. The method of any one of Aspects 53-65, wherein the inferred location comprises one or more of a virtual location, a location in a virtual environment representing a physical environment, a location scope defining an area within a range of the user device, a multidimensional location context associating spatial information with one or more of triggering features and information modules, or a multidimensional location context associating a range of spatial locations with at least one of an asset, an information module, or a triggering feature.

Aspect 67. The method of any one of Aspects 53-66, wherein determining, based on the association of the one or more triggering features and location information, the inferred location associated with the user device comprises determining, based on spatial data associating the one or more triggering features with a location at a premises, the inferred location.

Aspect 68. The method of any one of Aspects 53-67, wherein determining, based on the association of the one or more triggering features and location information, the inferred location associated with the user device comprises: determining first data associating triggering features with corresponding locations on one or more of a display or a shelf; determining second data associating the first data with a corresponding location at a premises; and determining, based on one or more of the triggering feature, the first data, or the second data, the inferred location associated with the user device.

Aspect 69. The method of any one of Aspects 53-68, wherein the association of the one or more triggering features and the location information is stored in one or more of a premises map, a planogram, or an association map associating one or more features or symbols with corresponding locations.

Aspect 70. The method of any one of Aspects 53-69, wherein the association of the one or more triggering features and the location information is one or more of input or updated by a user via one or more of a premises map, a shelf map, or an aisle map.

Aspect 71. The method of any one of Aspects 53-70, wherein the association with the triggering feature and the location information is one or more of determined by a computing device or updated by the computing device, and wherein the association is determined based on an event detected by the computing device.

Aspect 72. The method of Aspect 71, wherein the event detected by the computing device comprises detection of a change in a planogram, detection of a change in a placement of an asset, or detection of a change in a feature associated with asset.

Aspect 73. The method of any one of Aspects 53-72, wherein the location information associated with the environment comprises one or more of spatial information of a premises, layout information of a premises, aisle information of a premises, signage information of a premises, or rack information of a premises.

Aspect 74. The method of any one of Aspects 53-73, wherein the information profile comprises information associated with an asset at the inferred location, wherein the information associated with the asset at the inferred location comprises one or more of: task information, certification information, job function, skill information, an owner's manual, rental information, pricing information, training, instructional information, product safety information, product attachment information, accessory information, professional instruction and use content for the asset, a project planner for a project using a product, or product maintenance information.

Aspect 75. The method of any one of Aspects 53-74, wherein the user information comprises one or more of a user name, a user identifier, a user type, a user role, a user function, a user affiliation, a user employer, a user team, or a user organization.

Aspect 76. The method of any one of Aspects 53-75, wherein the user information comprises one or more of an experience level, an achievement level, a certification level, or a skill level.

Aspect 77. The method of Aspect 76, wherein one or more of the experience level, the achievement level, or the skill level is updated based on one or more of an event, a predetermined number of events associated with a user of the user device, a history of events, a user role, or a user training level.

Aspect 78. The method of any one of Aspects 53-77, wherein determining, based on the inferred location and the user information associated with the user device, the information profile comprises selecting one or more information modules from a plurality of modules.

Aspect 79. The method of Aspect 78, wherein the one or more information modules are one or more of selected, ranked, filtered, or output based on an association of the one or more information modules with the inferred location.

Aspect 80. The method of any one of Aspects 78-79, wherein the one or more information modules are one or more of selected, ranked, filtered, or output based on an association of the one or more information modules with at least a portion of the user information.

Aspect 81. The method of any one of Aspects 53-80, wherein the information profile comprises a plurality of information modules associated with a plurality of assets within viewing range of the inferred location.

Aspect 82. The method of any one of Aspects 53-81, wherein the information profile comprises a plurality of information modules associated with a plurality of assets within a threshold range of the inferred location.

Aspect 83. The method of any one of Aspects 53-82, wherein the information profile comprises a first information module associated with a first asset associated with a triggering feature of one or more triggering features and a second information module associated with a second asset, wherein the second information module is included in the information profile based on an association of the second asset with one or more of the first asset or the user information.

Aspect 84. A method comprising, consisting of, consisting essentially of, or comprising one or more of: generating, by a user device, imaging data associated with an image sensor and comprising one or more images of an environment in which the user device is located; determining, based on processing the imaging data, one or more triggering features; sending, to a computing device, a request for information associated with the one or more triggering features; receiving, based on sending the request, an information profile, wherein the information profile is based on an inferred location of the user device in the environment and user information associated with the user device, and wherein the inferred location is based on an association of the one or more triggering features and location information associated with the environment; and causing, based on receiving the information profile, output of the information profile (e.g., by sending the information to the user device, sending an identifier for accessing the information profile).

Aspect 85. The method of Aspect 84, wherein the one or more triggering features comprises one or more of a pattern, a shape, a size, text information, a color, a symbol, a graphic, a bar code, or an identifier.

Aspect 86. The method of any one of Aspects 84-85, wherein the one or more triggering features comprises an identifier of one or more of an asset, a price label, a sign, signage, a product, a shelf, a display, an aisle, an equipment, a workstation, or a service.

Aspect 87. The method of any one of Aspects 84-86, wherein the imaging data comprise one or more of a video, an image, an infrared image, a LIDAR image, a RADAR image, or an image comprising a projected pattern.

Aspect 88. The method of any one of Aspects 84-87, wherein determining the one or more triggering features comprises one or more of determining a plurality of triggering features, determining a pattern of triggering features, determining a plurality of feature vectors, identifying an object, inputting the imaging data into a machine learning model, performing optical character recognition, detecting a graphic, detecting a symbol, or determining that one or more characters indicate an identifier.

Aspect 89. The method of any one of Aspects 84-88, wherein the inferred location is based on one or more features in the environment matching the one or more triggering features and the one or more triggering features representing an identifier of one or more of an asset, a product, an object, a service, a physical location, or a virtual location.

Aspect 90. The method of any one of Aspects 84-89, wherein the inferred location is based on one or more of sensor data, a location inference rule, pattern recognition, or a machine learning model.

Aspect 91. The method of Aspect 90, wherein the sensor data comprises data from an accelerometer, a proximity sensor, an infrared sensor, a light sensor, a near field sensor, a global positioning sensor, a gyroscope, a temperature sensor, or a barometer.

Aspect 92. The method of any one of Aspects 90-91, wherein the location inference rule comprises a rule indicating the inferred location if a threshold number of the one or more triggering features are associated with the inferred location.

Aspect 93. The method of any one of Aspects 84-92, wherein the one or more triggering features comprises a plurality of triggering features, and wherein the inferred location is based on a pattern of least a portion of the plurality of triggering features being detected in the same imaging data.

Aspect 94. The method of any one of Aspects 84-93, wherein the inferred location comprises one or more of a location at a premises, a premises zone, a location associated with a shelf, a location associated with an aisle, a location associated with a department, a location associated with an asset category, a location associated with an asset grouping, a location associated with a service, a location associated with structure, or a location associated with a store front.

Aspect 95. The method of any one of Aspects 84-94, wherein the inferred location comprises one or more of a virtual location, a location in a virtual environment representing a physical environment, a location scope defining an area within a range of the user device, a multidimensional location context associating spatial information with one or more of triggering features and information modules, or a multidimensional location context associating a range of spatial locations with at least one of an asset, an information module, or a triggering feature.

Aspect 96. The method of any one of Aspects 84-95, wherein the inferred location is based on spatial data associating the triggering feature with a location at a premises.

Aspect 97. The method of any one of Aspects 84-96, wherein the inferred location is based on first data associating triggering features with corresponding locations on one or more of a display or a shelf and second data associating the first data with a corresponding location at a premises.

Aspect 98. The method of any one of Aspects 84-97, wherein the association of the one or more triggering features and the location information is stored in one or more of a premises map, a planogram, or an association map associating one or more features or symbols with corresponding locations.

Aspect 99. The method of any one of Aspects 84-98, wherein the association of the one or more triggering features and the location information is one or more of input or updated by a user via one or more of a premises map, a shelf map, or an aisle map.

Aspect 100. The method of any one of Aspects 84-99, wherein the association with the triggering feature and the location information is one or more of determined by a computing device or updated by the computing device, and wherein the association is determined based on an event detected by the computing device.

Aspect 101. The method of Aspect 100, wherein the event detected by the computing device comprises detection of a change in a planogram, detection of a change in a placement of an asset, or detection of a change in a feature associated with asset.

Aspect 102. The method of any one of Aspects 84-101, wherein the location information associated with the environment comprises one or more of spatial information of a premises, layout information of a premises, aisle information of a premises, signage information of a premises, or rack information of a premises.

Aspect 103. The method of any one of Aspects 84-102, wherein the information profile comprises information associated with an asset at the inferred location, wherein the information associated with the asset at the inferred location comprises one or more of: task information, certification information, job function, skill information, an owner's manual, rental information, pricing information, training, instructional information, product safety information, product attachment information, accessory information, professional instruction and use content for the asset, a project planner for a project using a product, or product maintenance information.

Aspect 104. The method of any one of Aspects 84-103, wherein the user information comprises one or more of a user name, a user identifier, a user type, a user role, a user function, a user affiliation, a user employer, a user team, or a user organization.

Aspect 105. The method of any one of Aspects 84-104, wherein the user information comprises one or more of an experience level, an achievement level, a certification level, or a skill level.

Aspect 106. The method of Aspect 105, wherein one or more of the experience level, the achievement level, or the skill level is updated based on one or more of an event, a predetermined number of events associated with a user of the user device, a history of events, a user role, or a user training level.

Aspect 107. The method of any one of Aspects 84-106, wherein the information profile comprise one or more information modules from a plurality of modules.

Aspect 108. The method of Aspect 107, wherein the one or more information modules are one or more of selected, ranked, filtered, or output based on an association of the one or more information modules with the inferred location.

Aspect 109. The method of any one of Aspects 107-108, wherein the one or more information modules are one or more of selected, ranked, filtered, or output based on an association of the one or more information modules with at least a portion of the user information.

Aspect 110. The method of any one of Aspects 84-109, wherein the information profile comprises a plurality of information modules associated with a plurality of assets within viewing range of the inferred location.

Aspect 111. The method of any one of Aspects 84-110, wherein the information profile comprises a plurality of information modules associated with a plurality of assets within a threshold range of the inferred location.

Aspect 112. The method of any one of Aspects 84-111, wherein the information profile comprises a first information module associated with a first asset associated with a triggering feature of one or more triggering features and a second information module associated with a second asset, wherein the second information module is included in the information profile based on an association of the second asset with one or more of the first asset or the user information.

Aspect 113. A method comprising, consisting of, consisting essentially of, or comprising one or more of: storing location information associated with an environment; determining an association of one or more triggering features with corresponding portions of the location information, wherein the one or more triggering features comprises a feature associated with processing an image of the environment; determining an association of asset information with the one or more triggering features and the location information; and causing, based on determining data indicative of the one or more triggering features and associated with imaging data of a user device, output, via the user device, of an information profile comprising the asset information, wherein the information profile is based on an inferred location associated with the user device and user information associated with the user device.

Aspect 114. The method of Aspect 113, wherein determining an association of asset information with the one or more triggering features and the location information comprises determining an association of first asset information with the one or more triggering features and determining an association of second asset information with the location information, wherein the information profile comprises the first asset information and the second asset information.

Aspect 115. The method of any one of Aspects 113-114, wherein storing location information associated with an environment comprises storing one or more of a schematic, a map, data indicating one or more spatial locations within the environment, or data indicating one or more virtual locations associated with the environment.

Aspect 116. The method of any one of Aspects 113-115, wherein determining the association of one or more triggering features with corresponding portions of the location information comprises analyzing data representing an environment, wherein the data comprises a planogram, an image, audio, or video.

Aspect 117. The method of Aspect 116, further comprising storing data indicating triggering features for a plurality of assets, wherein analyzing the data representing the environment comprises comparing detected features in the data to the data indicating the triggering features.

Aspect 118. The method of any one of Aspects 113-117, wherein the imaging data is received from the user device and processed to determine the data indicative of the one or more triggering features.

Aspect 119. The method of any one of Aspects 113-118, wherein the user device or an additional computing device processes the imaging data to determine the one or more triggering features.

Aspect 120. The method of any one of Aspects 113-119, wherein the one or more triggering features comprises one or more of a pattern, a shape, a size, text information, a color, a symbol, a graphic, a bar code, or an identifier.

Aspect 121. The method of any one of Aspects 113-120, wherein the one or more triggering features comprises an identifier of one or more of an asset, a price label, a sign, signage, a product, a shelf, a display, an aisle, an equipment, a workstation, or a service.

Aspect 122. The method of any one of Aspects 113-121, wherein the imaging data comprises one or more of a video, an image, an infrared image, a LIDAR image, a RADAR image, or an image comprising a projected pattern.

Aspect 123. The method of any one of Aspects 113-122, wherein determining the data indicative of the one or more triggering features comprises one or more of determining a plurality of triggering features, determining a pattern of triggering features, determining a plurality of feature vectors, identifying an object, inputting the imaging data into a machine learning model, performing optical character recognition, detecting a graphic, detecting a symbol, or determining that one or more characters indicate an identifier.

Aspect 124. The method of any one of Aspects 113-123, wherein the imaging data comprises one or more features in the environment and the inferred location is based on matching the one or more features to an identifier of one or more of an asset, a product, an object, a service, a physical location, or a virtual location.

Aspect 125. The method of any one of Aspects 113-124, wherein the inferred location is based on one or more of sensor data, a location inference rule, pattern recognition, or a machine learning model.

Aspect 126. The method of Aspect 125, wherein the sensor data comprises data from an accelerometer, a proximity sensor, an infrared sensor, a light sensor, a near field sensor, a global positioning sensor, a gyroscope, a temperature sensor, or a barometer.

Aspect 127. The method of any one of Aspects 125-126, wherein the location inference rule comprises a rule indicating the inferred location if a threshold number of the one or more triggering features are associated with the inferred location.

Aspect 128. The method of any one of Aspects 113-127, wherein the one or more triggering features comprises a plurality of triggering features, and wherein determining the inferred location comprises determining, based on a pattern of least a portion of the plurality of triggering features being detected in the same imaging data, the inferred location.

Aspect 129. The method of any one of Aspects 113-128, wherein the inferred location comprises one or more of a location at a premises, a premises zone, a location associated with a shelf, a location associated with an aisle, a location associated with a department, a location associated with an asset category, a location associated with an asset grouping, a location associated with a service, a location associated with structure, or a location associated with a store front.

Aspect 130. The method of any one of Aspects 113-129, wherein the inferred location comprises one or more of a virtual location, a location in a virtual environment representing a physical environment, a location scope defining an area within a range of the user device, a multidimensional location context associating spatial information with one or more of triggering features and information modules, or a multidimensional location context associating a range of spatial locations with at least one of an asset, an information module, or a triggering feature.

Aspect 131. The method of any one of Aspects 113-130, wherein the association of the one or more triggering features and corresponding portions of the location information comprises an association of spatial data and triggering feature with a location at a premises.

Aspect 132. The method of any one of Aspects 113-131, determining an association of one or more triggering features with corresponding portions of the location information comprises: determining first data associating triggering features with corresponding locations on one or more of a display or a shelf; and determining second data associating the first data with a corresponding location at a premises, wherein the inferred location is based on one or more of the triggering feature, the first data, or the second data, the inferred location associated with the user device.

Aspect 133. The method of any one of Aspects 113-132, wherein the association of the one or more triggering features and the corresponding portions of the location information is stored in one or more of a premises map, a planogram, or an association map associating one or more features or symbols with corresponding locations.

Aspect 134. The method of any one of Aspects 113-133, wherein the association of the one or more triggering features and the corresponding portions of the location information is one or more of input or updated by a user via one or more of a premises map, a shelf map, or an aisle map.

Aspect 135. The method of any one of Aspects 113-134, wherein the association with the one or more triggering features and the corresponding portions of the location information is one or more of determined by a computing device or updated by the computing device, and wherein the association is determined based on an event detected by the computing device.

Aspect 136. The method of Aspect 135, wherein the event detected by the computing device comprises detection of a change in a planogram, detection of a change in a placement of an asset, or detection of a change in a feature associated with asset.

Aspect 137. The method of any one of Aspects 113-136, wherein the location information associated with the environment comprises one or more of spatial information of a premises, layout information of a premises, aisle information of a premises, signage information of a premises, or rack information of a premises.

Aspect 138. The method of any one of Aspects 113-137, wherein the information profile comprises information associated with an asset at the inferred location, wherein the information associated with the asset at the inferred location comprises one or more of: task information, certification information, job function, skill information, an owner's manual, rental information, pricing information, training, instructional information, product safety information, product attachment information, accessory information, professional instruction and use content for the asset, a project planner for a project using a product, or product maintenance information.

Aspect 139. The method of any one of Aspects 113-138, wherein the user information comprises one or more of a user name, a user identifier, a user type, a user role, a user function, a user affiliation, a user employer, a user team, or a user organization.

Aspect 140. The method of any one of Aspects 113-139, wherein the user information comprises one or more of an experience level, an achievement level, a certification level, or a skill level.

Aspect 141. The method of Aspect 140, wherein one or more of the experience level, the achievement level, or the skill level is updated based on one or more of an event, a predetermined number of events associated with a user of the user device, a history of events, a user role, or a user training level.

Aspect 142. The method of any one of Aspects 113-141, wherein the information profile is determined from one or more information modules from a plurality of modules.

Aspect 143. The method of Aspect 142, wherein the one or more information modules are one or more of selected, ranked, filtered, or output based on an association of the one or more information modules with the inferred location.

Aspect 144. The method of anyone of Aspects 142-143, wherein the one or more information modules are one or more of selected, ranked, filtered, or output based on an association of the one or more information modules with at least a portion of the user information.

Aspect 145. The method of any one of Aspects 113-144, wherein the information profile comprises a plurality of information modules associated with a plurality of assets within viewing range of the inferred location.

Aspect 146. The method of any one of Aspects 113-145, wherein the information profile comprises a plurality of information modules associated with a plurality of assets within a threshold range of the inferred location.

Aspect 147. The method of any one of Aspects 113-146, wherein the information profile comprises a first information module associated with a first asset associated with a triggering feature of one or more triggering features and a second information module associated with a second asset, wherein the second information module is included in the information profile based on an association of the second asset with one or more of the first asset or the user information.

Aspect 148. A device comprising, consisting of, consisting essentially of, or comprising one or more of: one or more processors; and a memory storing instructions that, when executed by the one or more processors, cause the device to perform the methods of any one of Aspects 1-147.

Aspect 149. A non-transitory computer-readable medium storing instructions that, when executed by one or more processors, cause a device to perform the methods of any one of Aspects 1-147.

Aspect 150. A system comprising, consisting of, consisting essentially of, or comprising one or more of: one or more location units configured to communicate location information associated with a plurality of locations; and a computing device configured to perform the methods of any one of Aspects 1-147, wherein the data indicative of the location is determined based on at least a portion of the location information.

Aspect 151. A system comprising, consisting of, consisting essentially of, or comprising one or more of: a user device located in an environment; and a computing device configured to perform the methods of any one of Aspects 1-147.

It is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Components are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described herein with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described above may be used independently of one another, or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are illustrated as being stored in memory or on storage while being used, and that these items or portions thereof may be transferred between memory and other storage devices for purposes of memory management and data integrity. Alternatively, in other embodiments, some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

What is claimed is:

1. A method comprising:
receiving, from a mobile user device, a request comprising data indicative of a location of the user device, wherein the request is generated in response to the user device interacting with a trigger associated with one or more the location, a service, or an asset, and interacting with the trigger occurs via at least one of: scanning a trigger, capturing an image of the trigger or causing the mobile user device to be within a predetermined range of the trigger, and wherein the trigger is one of: a near-field communication (NFC) tag, a radio frequency identification (RFID) tag, a Quick-Response (QR) code, a barcode or a beacon;
determining, based on receiving the request, user information associated with a user of the mobile user device;
generating, based on the user information and the data indicative of the location, an information profile relevant to a context of the user at the location;
determining, based on the data indicative of the location, an asset at the location; and
transmitting, to the mobile user device, the information profile, wherein the information profile provides one or more actions or information related to the asset, service or location.

2. The method of claim 1, wherein the data indicative of the location comprises data generated based on a positioning system of the user device, wherein the positioning system comprises one or more of a global positioning system, a wireless signal positioning system, an ultrawide band positioning system, a sound based positioning system, a beacon based positioning system, a Bluetooth beacon positioning system, an inertial positioning system, an accelerometer, or a device or tag that indicates the location.

3. The method of claim 1, wherein the user information comprises one or more of a user name, a user identifier, user experience level, user skills, a user type, a user role, a user function, a user affiliation, a user employer, a user team, or a user organization.

4. The method of claim 1, wherein the data indicative of the location comprises one or more of an asset location at a premises, a premises location, a global positioning coordinate, a geospatial location within a premises, a location history, a shelf location, a premises zone, a container, an aisle, a department of a premises, a location range, or a tagged location.

5. The method of claim 1, further comprising determining a service information based one or more of the data indicative of the location, the request, or the user information.

6. The method of claim 1, further comprising storing a history of events associated with the user, wherein one or more of the events are associated with one or more of the location, a corresponding action performed at the location, or a corresponding asset at the location.

7. The method of claim 6, further comprising determining a pattern based on the history of events, wherein the pattern is determined based on one or more of the history of events associated with the user or a history of events associated with a plurality of users.

8. The method of claim 7, wherein the information profile comprises information selected for the information profile based on the pattern.

9. The method of claim 1, further comprising generating one or more models configured to predict relevance of an information module of one or more information modules to a context, wherein the one or more information modules are selected based on the one or more models.

10. The method of claim 9, wherein the context comprises one or more of a location characteristic, a user characteristic, or an asset characteristic of an asset at the location, wherein the location characteristic comprises a location identifier, a location category, a location within a premises, a shelf location, or a geographic boundary, wherein the user characteristic comprises one or more of a user role, a user experience level, a prior event associated with a user, a user permission level, or occurrence of a set of events being associated with a user, wherein the asset characteristic comprises a prior event associated with the asset, a scheduled event associated with the asset, an action associated with managing the asset, or an asset category.

11. The method of claim 10, further comprising tracking one or more interactions of the user with the information profile and training the one or more models based on the one or more interactions.

12. An apparatus comprising:
a network interface configured to enable network communications;
a memory; and
one or more processors coupled to the network interface and the memory, wherein the one or more processors are configured to perform operations including:
receiving, from a mobile user device, a request comprising data indicative of a location of the user device, wherein the request is generated in response to the user device interacting with a trigger associated with one or more the location, a service, or an asset, and interacting with the trigger occurs via at least one of: scanning a trigger, capturing an image of the trigger or causing the mobile user device to be within a predetermined range of the trigger, and wherein the trigger is one of: a near-field communication (NFC) tag, a radio frequency identification (RFID) tag, a Quick-Response (QR) code, a barcode or a beacon;
determining, based on receiving the request, user information associated with a user of the mobile user device;
generating, based on the user information and the data indicative of the location, an information profile relevant to a context of the user at the location;
determining, based on the data indicative of the location, an asset at the location; and
transmitting, to the mobile user device, the information profile, wherein the information profile provides one or more actions or information related to the asset, service or location.

13. The apparatus of claim 12, wherein the data indicative of the location comprises data generated based on a positioning system of the user device, wherein the positioning system comprises one or more of a global positioning system, a wireless signal positioning system, an ultrawide band positioning system, a sound based positioning system, a beacon based positioning system, a Bluetooth beacon positioning system, an inertial positioning system, an accelerometer, or a device or tag that indicates the location.

14. The apparatus of claim 12, wherein the one or more processors are further configured to store a history of events associated with the user, wherein one or more of the events are associated with one or more of the location, a corresponding action performed at the location, or a corresponding asset at the location.

15. The apparatus of claim 14, wherein the one or more processors are further configured to determine a pattern based on the history of events, wherein the pattern is determined based on one or more of the history of events associated with the user or a history of events associated with a plurality of users.

16. The apparatus of claim 12, wherein the one or more processors are further configured to generate one or more models configured to predict relevance of an information module of one or more information modules to a context, wherein the one or more information modules are selected based on the one or more models, wherein the context comprises one or more of a location characteristic, a user characteristic, or an asset characteristic of an asset at the location, wherein the location characteristic comprises a location identifier, a location category, a location within a premises, a shelf location, or a geographic boundary, wherein the user characteristic comprises one or more of a user role, a user experience level, a prior event associated with a user, a user permission level, or occurrence of a set of events being associated with a user, wherein the asset characteristic comprises a prior event associated with the asset, a scheduled event associated with the asset, an action associated with managing the asset, or an asset category.

17. One or more non-transitory computer-readable storage media encoded with instructions that, when executed by a processor, cause the processor to perform operations including:
receiving, from a mobile user device, a request comprising data indicative of a location of the user device, wherein the request is generated in response to the user device interacting with a trigger associated with one or more the location, a service, or an asset, and interacting with the trigger occurs via at least one of: scanning a trigger, capturing an image of the trigger or causing the mobile user device to be within a predetermined range of the trigger, and wherein the trigger is one of: a near-field communication (NFC) tag, a radio frequency identification (RFID) tag, a Quick-Response (QR) code, a barcode or a beacon;
determining, based on receiving the request, user information associated with a user of the mobile user device;
generating, based on the user information and the data indicative of the location, an information profile relevant to a context of the user at the location;
determining, based on the data indicative of the location, an asset at the location; and
transmitting, to the mobile user device, the information profile, wherein the information profile provides one or more actions or information related to the asset, service or location.

18. The non-transitory computer-readable storage media of claim 17, wherein the data indicative of the location comprises data generated based on a positioning system of the user device, wherein the positioning system comprises one or more of a global positioning system, a wireless signal positioning system, an ultrawide band positioning system, a sound based positioning system, a beacon based positioning system, a Bluetooth beacon positioning system, an inertial positioning system, an accelerometer, or a device or tag that indicates the location.

19. The non-transitory computer-readable storage media of claim 17, further comprising instructions that, when executed by the processor, caused the processor to store a history of events associated with the user, wherein one or more of the events are associated with one or more of the location, a corresponding action performed at the location, or a corresponding asset at the location.

20. The non-transitory computer-readable storage media of claim 19, further comprising instructions that, when executed by the processor, caused the processor to determine a pattern based on the history of events, wherein the pattern is determined based on one or more of the history of events associated with the user or a history of events associated with a plurality of users.
